(19) United States
(12) Patent Application Publication
(10) Pub. No.: US 2019/0215464 A1
(43) Pub. Date: Jul. 11, 2019

(54) SYSTEMS AND METHODS FOR DECOMPOSING A VIDEO STREAM INTO FACE STREAMS

(71) Applicant: Blue Jeans Network, Inc., Mountain View, CA (US)

(72) Inventors: Navneet Kumar, Bengaluru (IN); Ashish Nagpal, Bengaluru (IN); Satish Malalaganv Ramakrishna, Karnataka (IN)

(21) Appl. No.: 15/902,854

(22) Filed: Feb. 22, 2018

(30) Foreign Application Priority Data
Jan. 11, 2018 (IN) 201811001280

(51) Int. Cl. H04N 5/262; G06K 9/00; G10L 17/00; H04N 7/08; H04N 5/445; H04N 7/15

(52) U.S. Cl. CPC H04N 5/2628; G06K 9/00288; G10L 17/005; G06F 3/0482; H04N 5/44591; H04N 7/15; H04N 7/08

(57) ABSTRACT

An audio/video stream may include an audio stream and a video stream. The video stream may be decomposed into a plurality of face streams. Each of the face streams may include a cropped version of the video stream and be focused on the face of one of the individuals captured in the video stream. Facial recognition may be used to associate each of the face streams with an identity of the individual captured in the respective face stream. Additionally, voice recognition may be used to recognize the identity of the active speaker in the audio stream. The face stream associated with an identity matching the active speaker's identity may be labeled as the face stream of the active speaker. In a “Room SplitView” mode, the face stream of the active speaker is rendered in a more prominent manner than the other face streams.

### CROSS REFERENCE TO RELATED APPLICATIONS

This application claims the priority benefit of Indian Application No. 201811001280, filed on 11 Jan. 2018, the disclosure of which is incorporated herein by reference in its entirety.

### FIELD OF THE INVENTION

The present invention is related to the processing and display of a video stream, and more particularly, in one embodiment, relates to decomposing a video stream into a plurality of face streams (e.g., a face stream being a video stream capturing the face of an individual), in another embodiment, relates to tracking an active speaker by correlating facial and vocal biometric data of the active speaker, in another embodiment, relates to configuring a user interface in “Room SplitView” mode in which one of the face streams is rendered in a more prominent fashion than another one of the face streams, and in another embodiment, relates to decomposing a video stream into a plurality of face streams, which are each labeled with an identity of the individual captured in the respective face stream.

### BACKGROUND

In a conventional video conference, a group of invited participants may join from a room video conference endpoint and others may join from personal endpoint devices (e.g., a laptop, a mobile phone, etc.). Described herein are techniques for enhancing the user experience in such a context or similar contexts.

### SUMMARY

In one embodiment of the invention, facial detection may be used to decompose a video stream into a plurality of face streams. Each of the face streams may be a cropped version of the video stream and focused on the face of an individual captured in the video stream. For instance, in the case of two individuals captured in the video stream, a first face stream may capture the face of the first individual, but not the face of the second individual, while a second face stream may capture the face of the second individual, but not the face of the first individual. The plurality of face streams may be rendered in a “Room SplitView” mode, in which one of the face streams is rendered in a more prominent manner than another one of the face streams.

In another embodiment of the invention, facial recognition may be used to decompose a video stream into a plurality of face streams. Facial recognition may allow each of the face streams to be associated with an identity of the individual captured in the respective face stream. The plurality of face streams may be rendered in a “Room SplitView” mode, in which one of the face streams is rendered in a more prominent manner than another one of the face streams. Further, the rendered face streams may be labeled with the identity of the user captured in the respective face stream.

In another embodiment of the invention, facial recognition and voice recognition may be used to decompose a video stream into a plurality of face streams. Facial recognition may allow each of the face streams to be associated with an identity of the individual captured in the respective face stream. Additionally, voice recognition may be used to recognize the identity of the active speaker. If the identity of the active speaker matches the identity associated with one of the face streams, the face stream with the matching identity may be labeled as the face stream of the active speaker. The plurality of face streams may be rendered in a “Room SplitView” mode, in which the face stream of the active speaker is rendered in a more prominent manner than the other face streams.

In another embodiment of the invention, facial detection may be used to generate a plurality of location streams for a video stream (e.g., a location stream identifying the changing location of the face of an individual captured in the video stream). When rendering the video stream, the client device may use the location streams to digitally pan and zoom into any one of the individuals captured in the video stream.

In another embodiment of the invention, facial recognition may be used to generate a plurality of location streams for a video stream, each of the location streams associated with an identity of the individual tracked in the location stream. When rendering the video stream, the client device may use the location streams to digitally pan and zoom into any one of the individuals captured in the video stream. Additionally, the identity information provided by the facial recognition may be used to label (e.g., with names) each of the individuals rendered in the video stream.

In another embodiment of the invention, facial recognition and voice recognition may be used to generate a plurality of location streams for a video stream. Facial recognition may be used to associate each of the location streams with an identity of the individual tracked in the respective location stream. Additionally, voice recognition may be used to recognize the identity of the active speaker. If the identity of the active speaker matches the identity associated with one of the location streams, the location stream with the matching identity may be labeled as the location stream of the active speaker. When rendering the video stream, the client device may use the location stream of the active speaker to automatically pan and zoom into the active speaker. Additionally, the identity information provided by the facial recognition may be used to label (e.g., with names) each of the individuals rendered in the video stream.

These and other embodiments of the invention are more fully described in association with the drawings below.

### BRIEF DESCRIPTION OF THE DRAWINGS

FIG. 1A depicts a system diagram of a video conference system with a video decomposition system, in accordance with one embodiment of the invention;

FIG. 1B depicts further details of the video decomposer depicted in FIG. 1A, in accordance with one embodiment of the invention;

FIG. 1C depicts a user interface at a client device for interfacing with participants of a video conference who are situated in the same room (i.e., participants of a room video conference), in accordance with one embodiment of the invention;

FIG. 1D depicts a user interface at a client device in a “Room SplitView” mode, in which one of the participants is presented in a more prominent fashion than the other participants, in accordance with one embodiment of the invention;

FIG. 2A depicts a system diagram of a video conference system with a video decomposition system, in accordance with one embodiment of the invention;

FIG. 2B depicts further details of the video decomposer depicted in FIG. 2A, in accordance with one embodiment of the invention;

FIG. 2C depicts a user interface at a client device for interfacing with participants of a room video conference system, in accordance with one embodiment of the invention;

FIG. 2D depicts a user interface at a client device in a “Room SplitView” mode, in accordance with one embodiment of the invention;

FIG. 2E depicts a user interface at a client device with a drop-down menu for selecting one of the participants to be more prominently displayed in a “Room SplitView” mode, in accordance with one embodiment of the invention;

FIG. 3A depicts a system diagram of a video conference system with a video decomposition system, in accordance with one embodiment of the invention;

FIG. 3B depicts further details of the video decomposer depicted in FIG. 3A, in accordance with one embodiment of the invention;

FIG. 3C depicts a user interface at a client device in a “Room SplitView” mode, in accordance with one embodiment of the invention;

FIG. 4A depicts a system diagram of a video conference system with a video processing system, in accordance with one embodiment of the invention;

FIG. 4B depicts further details of the face detector depicted in FIG. 4A, in accordance with one embodiment of the invention;

FIGS. 4C-4E depict a user interface at a client device for interfacing with participants of a room video conference system (illustrating a zooming and panning functionality), in accordance with one embodiment of the invention;

FIG. 5A depicts a system diagram of a video conference system with a video processing system, in accordance with one embodiment of the invention;

FIG. 5B depicts further details of the face recognizer depicted in FIG. 5A, in accordance with one embodiment of the invention;

FIGS. 5C-5E depict a user interface at a client device for interfacing with participants of a room video conference system (illustrating a zooming and panning functionality), in accordance with one embodiment of the invention;

FIG. 6A depicts a system diagram of a video conference system with a video processing system, in accordance with one embodiment of the invention;

FIG. 6B depicts further details of the data processor depicted in FIG. 6A, in accordance with one embodiment of the invention;

FIGS. 6C-6E depict a user interface at a client device for interfacing with participants of a room video conference system (illustrating a zooming and panning functionality), in accordance with one embodiment of the invention;

FIG. 7 depicts a flow diagram of a process for decomposing a first video stream into a second and third video stream, in accordance with one embodiment of the invention;

FIG. 8 depicts a flow diagram of a process for decomposing a first video stream into a second and third video stream and labeling one of the decomposed video streams as containing an active speaker, in accordance with one embodiment of the invention;

FIG. 9 depicts a flow diagram of a process for receiving a plurality of decomposed video streams, receiving a selection of one of the decomposed streams, and displaying the selected stream in a more prominent manner than the non-selected streams, in accordance with one embodiment of the invention;

FIG. 10 depicts a flow diagram of a process for receiving a video stream, receiving a selection of one of the individuals captured in the video stream, and panning to and zooming in on the face of the selected individual, in accordance with one embodiment of the invention;

FIG. 11 depicts a flow diagram of a process for decomposing a first video stream into a second and third video stream, and further associating each of the decomposed streams with an individual captured in the decomposed stream, in accordance with one embodiment of the invention; and

FIG. 12 depicts a block diagram of an exemplary computing system in accordance with some embodiments of the invention.

### DETAILED DESCRIPTION

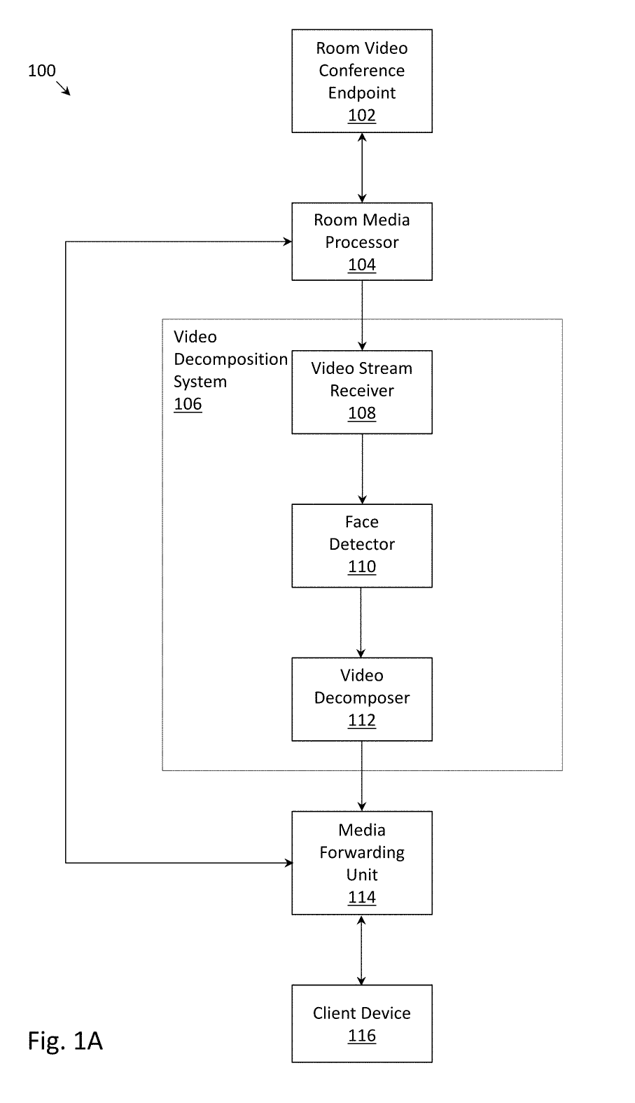

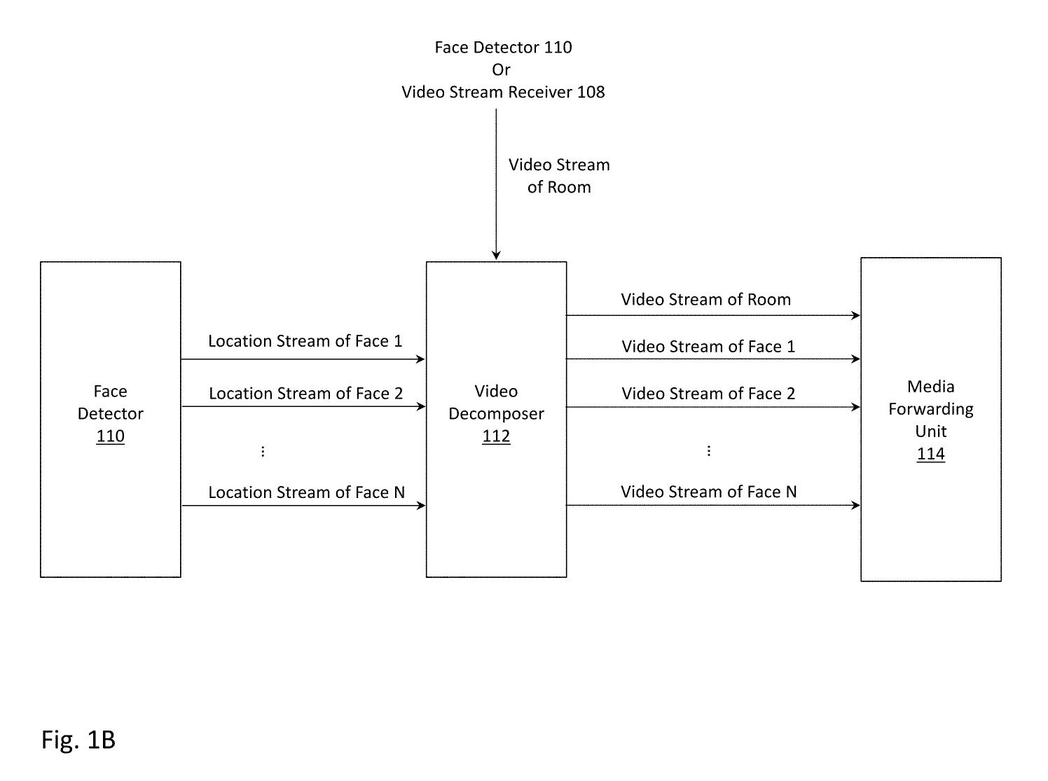

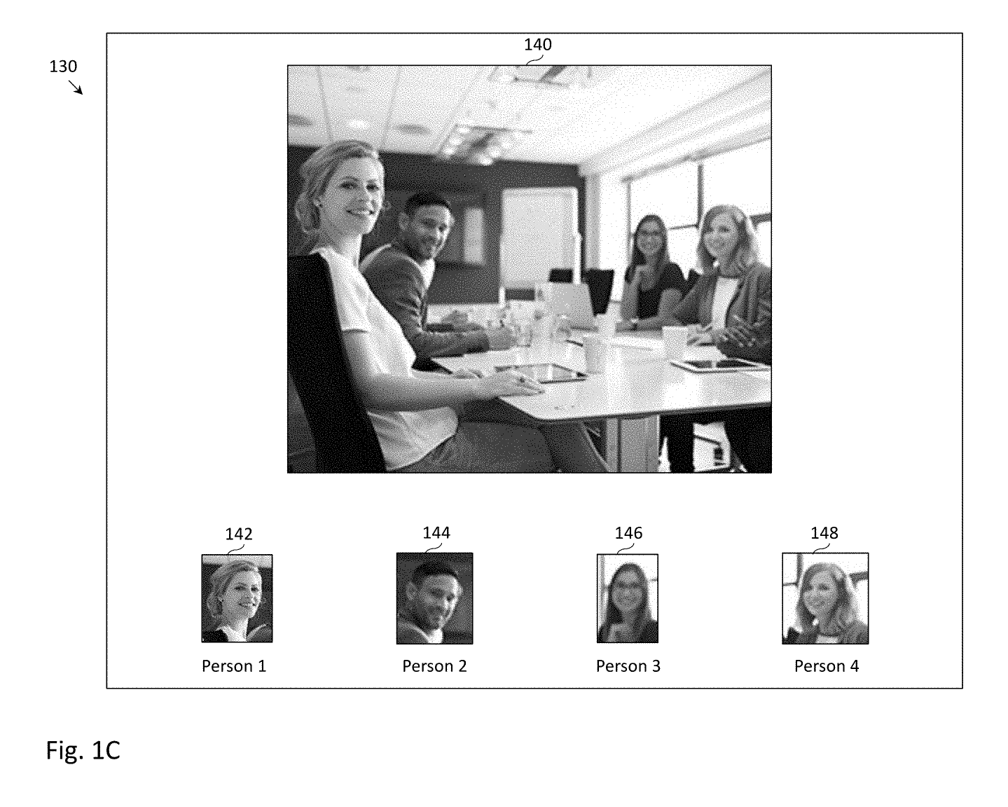

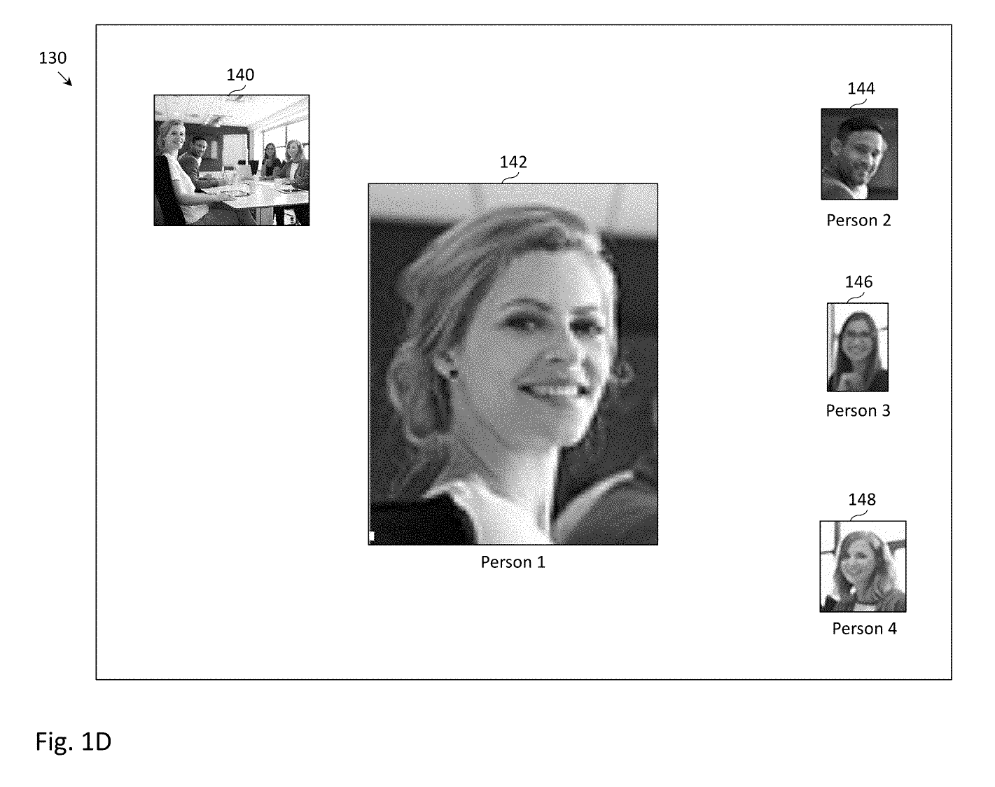

FIG. 1A depicts a system diagram of video conference system 100, in accordance with one embodiment of the invention. Video conference system 100 may include room video conference endpoint 102. A room video conference endpoint generally refers to an endpoint of a video conference system in which participants of the video conference are located in the same geographical area. For convenience of description, such geographical area will be called a “room”, but it is understood that the room could refer to an auditorium, a lecture hall, a gymnasium, a park, etc. Typically, only one of the individuals in the room speaks at any time instance (hereinafter, called the “active speaker”) and the other individuals are listeners. Occasionally, one of the listeners may interrupt the active speaker and take over the role of the active speaker, and the former active speaker may transition into a listener. Thus, there may be brief time periods in which two (or possibly more) of the individuals speak at the same time. There may also be times when all the individuals in the room are listeners, and the active speaker is located at a site remote from room video conference endpoint 102.

Room video conference endpoint 102 may include one or more video cameras to receive visual input signals and one or more microphones to receive audio signals. The visual input signals and audio signals may be combined and encoded into a single audio/video (A/V) stream. The H.323 or SIP protocol may be used to transmit the A/V stream from room video conference endpoint 102 to room media processor 104. In many embodiments of the invention, the video stream will simultaneously (i.e., at any single time instance), capture multiple individuals who are located in the room (e.g., four individuals seated around a conference table). Room video conference endpoint 102 may also include one or more displays to display a video stream and one or more speakers to play an audio stream captured at one or more endpoints remote from room video conference endpoint 102 (e.g., client device 116).

Room media processor 104 may decode the A/V stream received from room video conference endpoint 102 into an audio stream and a room video stream (the term “room video stream” is used to refer to the video stream captured at room video conference endpoint 102, as distinguished from other video streams that will be discussed below). Video stream receiver 108 of video decomposition system 106 may receive the room video stream decoded by room media processor 104, and forward the room video stream to face detector 110.

Face detector 110 of video decomposition system 106 may be configured to detect one or more faces that are present in a frame of the room video stream, and further utilize algorithms such as the Continuously Adaptive Mean Shift (CAMShift) algorithm to track the movement of the one or more detected faces in later frames of the room video stream. An example facial detection algorithm is the Viola-Jones algorithm proposed by Paul Viola and Michael Jones. Facial detection algorithms and tracking algorithms are well-known in the field and will not be discussed herein for conciseness. The output of face detector 110 may be a location of each of the faces in the initial frame, followed by an updated location of each of the faces in one or more of the subsequent frames. Stated differently, face detector 110 may generate a time-progression of the location of a first face, a time-progression of the location of a second face, and so on.

The location of a face may be specified in a variety of ways. In one embodiment, the location of a face (and its surrounding area) may be specified by a rectangular region that includes the head of a person. The rectangular region may be specified by the (x, y) coordinates of the top left corner of the rectangular region (or any other corner) in association with the width and height of the rectangular region (e.g., measured in terms of a number of pixels along a horizontal or vertical dimension within a frame). It is possible that the rectangular region includes more than just the head of a person. For example, the rectangular region could include the head, shoulders, neck and upper chest of a person. Therefore, while the phrase “face detection” is being used, it is understood that such phrase may more generally refer to “head detection” or “head and shoulder detection”, etc. Other ways to specify the location of a face (and its surrounding area) are possible. For instance, the location of a face could be specified by a circular region, with the center of circular region set equal to the location of the nose of the face and the radius of the circular region specified so that the circular region includes the head of a person.

Face detector 110 may also return a confidence number (e.g., ranging from 0 [not confident] to 100 [completely confident]) that specifies the confidence with which a face has been detected (e.g., a confidence that a region of the frame returned by face detector corresponds to a human face, as compared to something else). Various factors could influence the confidence with which a face has been detected, for example, the size of a face (e.g., number of pixels which makes up a face), the lighting conditions of the room, whether the face is partially obstructed by hair, the orientation of the face with respect to a video camera of room video conference endpoint 102, etc.

Example output from face detector 110 is provided below for a specific frame:

```
{
      “frameTimestamp”: “00:17:20.7990000”,
      “faces”: [
            {
                  “id”: 123,
                  “confidence”: 90,
                  “faceRectangle”: {
                        “width”: 78,
                        “height”: 78,
                        “left”: 394,
                        “top”: 54
                  }
            },
            {
                  “id”: 124,
                  “confidence”: 80,
                  “faceRectangle”: {
                        “width”: 120,
                        “height”: 110,
                        “left”: 600,
                        “top”: 10
                  }
            }
      ],
}
```

If not already apparent, “frameTimestamp” may record a timestamp of the frame; and for each of the detected faces in the frame, “id” may record an identity of the face, “confidence” may record the likelihood that the location specified by “faceRectangle” corresponds to a human face, and “faceRectangle” may record the location of the face.

Video decomposer 112 of video decomposition system 106 may receive the room video stream from either video stream receiver 108 or face detector 110. Video decomposer 112 may also receive the location of each of the faces in the room video stream from face detector 110 (along with any confidence number indicating the detection confidence). For a detected face with a confidence number above a certain threshold (e.g., >50), the detected face may be cropped from a frame of the room video stream using the location information provided by face detector 110. For example, the cropped portion of the frame may correspond to a rectangular (or circular) region specified by the location information. Image enhancement (e.g., image upscaling, contrast enhancement, image smoothing/sharpening, aspect ratio preservation, etc.) may be applied by video decomposer 112 to each of the cropped faces. Finally, the image-enhanced cropped faces corresponding to a single individual from successive frames may be re-encoded into a video stream using a video codec and sent to media forwarding unit (MFU) 114 on a data-channel (e.g., RTCP channel, WebSocket Channel). One video stream may be sent to MFU 114 for each of the detected faces. In addition, the room video stream may be sent to MFU 114. To summarize, video decomposer 112 may receive a room video stream and decompose that room video stream into individual video streams, which are each focused on a face (or other body region) of a single person located in the room. Such individual video streams may be, at times, referred to as “face streams”. Any client device (also called an endpoint), such as client device 116, which is connected to MFU 114 may receive these face streams as well as the room video stream from MFU 114, and the client devices can selectively display (or focus on) one or more of these streams. Examples of client devices include laptops, mobile phones, and tablet computers, but can also include a room video conference endpoint, similar to room video conference endpoint 102.

In addition, MFU 114 may receive the audio stream portion of the A/V stream directly from room media processor 104 (or it may be forwarded to MFU 114 from video decomposition system 106). The audio stream may be forwarded from MFU 114 to client device 116, and the audio stream may be played by client device 116.

FIG. 1B depicts further details of video decomposer 112 depicted in FIG. 1A, in accordance with one embodiment of the invention. As explained above, video decomposer 112 may receive a time progression of the location of each of the faces in the room video stream (i.e., “location streams”). These location streams are depicted in FIG. 1B as “Location Stream of Face 1, Location Stream of Face 2, . . . Location Stream of Face N”, where “Location Stream of Face 1” represents the changing location of a face of a first person, and so on. Video decomposer may also receive room video stream (depicted as “Video Stream of Room” in FIG. 1B). Video decomposer 112 may generate N face streams based on the room video stream and the N location streams. The N face streams are depicted in FIG. 1B as “Video Stream of Face 1, Video Stream of Face 2, . . . Video Stream of Face N”, where “Video Stream of Face 1” represents a cropped version of the room video stream which focuses on the face of the first person, and so on. These N face streams as well as the room video stream may be transmitted to MFU 114. It is noted that FIG. 1B is not meant to be a comprehensive illustration of the input/output signals to/from video decomposer 112. For instance, video decomposer 112 may also receive confidence values from face detector 110, but such input signal has not been depicted in FIG. 1B for conciseness.

FIG. 1C depicts user interface 130 at client device 116 for interfacing one or more users of client device 116 with participants of room video conference endpoint 102, in accordance with one embodiment of the invention. Room video stream may be rendered in user interface 130 (the rendered version of a frame of the room video stream labeled as 140). In the example of FIG. 1C, four participants are captured in the room video stream. Accordingly, four face streams may also be rendered in user interface 130. Rendered frames from the four face streams (i.e., frames with same time stamp) (labeled as 142, 144, 146 and 148) may be tagged as “Person 1”, “Person 2”, “Person 3” and “Person 4”, respectively. Since the embodiment of FIG. 1A merely detect faces (and may not be able to associate faces with named individuals), the tags may only reference distinct, but anonymous individuals. User interface 130 is in a “Room FullView” mode, because the room video stream is rendered in a more prominent manner, as compared to the face streams. Further, the dimensions of the rendered face streams may be substantially similar to one another in the “Room FullView” mode.

An advantage to rendering the face streams in addition to the room video stream is that often times, some individuals in a room video stream may not appear clearly (e.g., may appear smaller because they are farther away from the video camera, or appear with low contrast because they are situated in a dimly lit part of the room). With the use of face streams, a user of client device 116 may be able to clearly see the faces of all participants of room video conference endpoint 102 (e.g., as a result of the image processing performed by video decomposer 112). In some instances, a face in a face stream may be rendered in a zoomed-out manner as compared to the corresponding face in the room video stream (see, e.g., person 1 in the example of FIG. 1C), while in other instances, a face in a face stream may be rendered in a zoomed-in manner as compared to the corresponding face in the room video stream (see, e.g., person 3 in the example of FIG. 1C). For example, as shown in FIG. 1C, each rendered face stream may be sized to have a common height in user interface 130.

In response to one of the individuals being selected by a user of client device 116, user interface 130 may transition from the “Room FullView” mode to a “Room SplitView” mode depicted in FIG. 1D, in which the face stream of the selected individual is depicted in a more prominent manner than the face streams of the other individuals. The selection of an individual may be performed by using a cursor controlling device to select a region of user interface 130 on which the individual is displayed. The individual selected may be, e.g., an active speaker, a customer, a manager, etc. Other methods for selecting an individual are possible. For example, a user could select “Person 1” by speaking “Person 1” and the selection of the individual could be received via a microphone of client device 116.

In the example of FIG. 1D, it is assumed that person 1 is selected, and as a result of such selection, the face stream of person 1 is rendered in a more prominent manner than the face streams of the other individuals in the room. A face stream may be rendered in a more prominent manner by using more pixels of the display of client device 116 to render the face stream, by rendering the face stream in a central location of the user interface, etc. In contrast, a face stream may be rendered in a less prominent manner by using less pixels of the display to render the face stream, by rendering the face stream in an off-center location (e.g., side) of the user interface, etc. The “Room SplitView” mode may also render the room video stream, but in a less prominent manner than the face stream of the selected individual (as shown in FIG. 1D).

It is noted that the specific locations of the rendered video streams depicted in FIG. 1D should be treated as examples only. For instance, while the face streams of persons 2, 3 and 4 were rendered in a right side (i.e., right vertical strip) of user interface 130, they could have instead been rendered in a left side (i.e., left vertical strip) of the user interface. Further, the room video stream could have been rendered in a lower right portion of user interface 130 instead of the upper left portion.

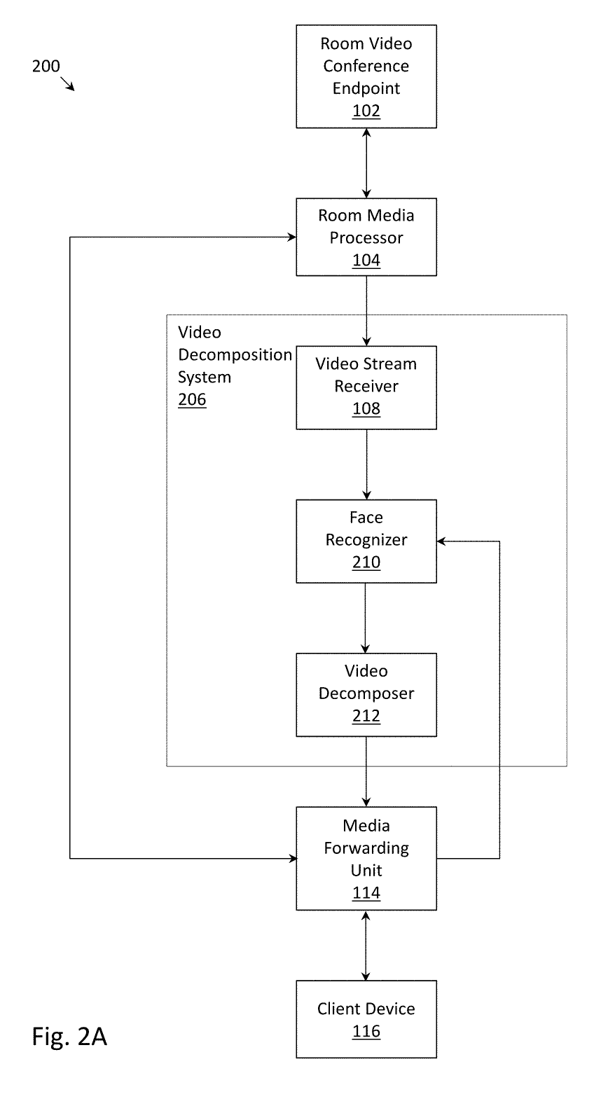

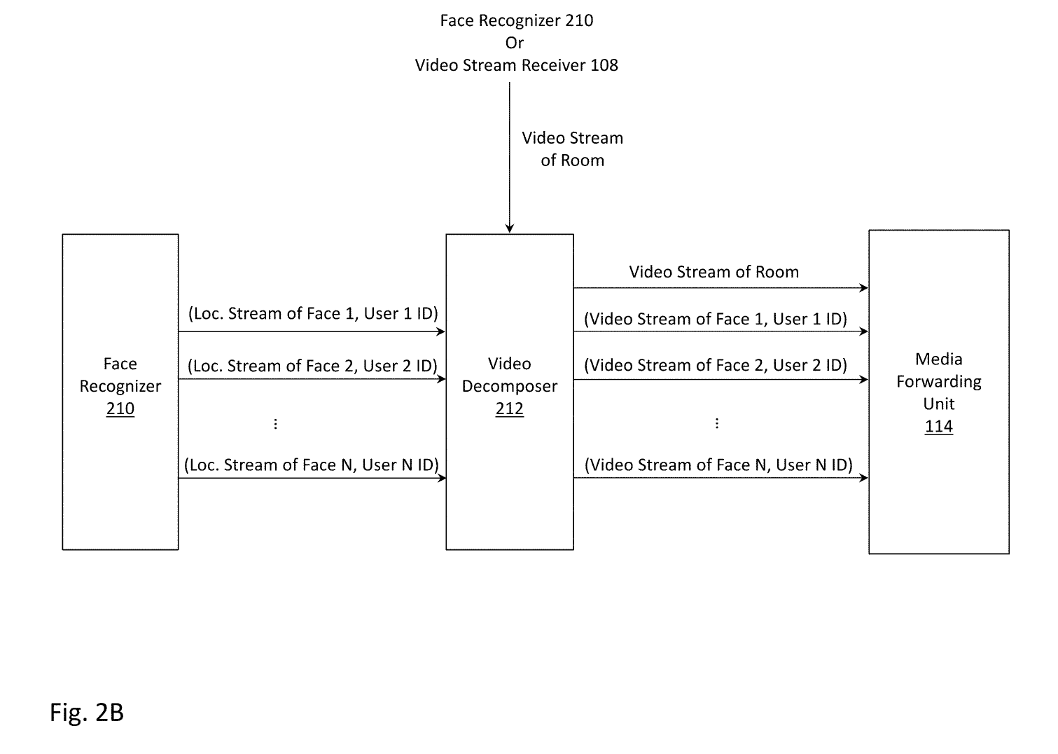

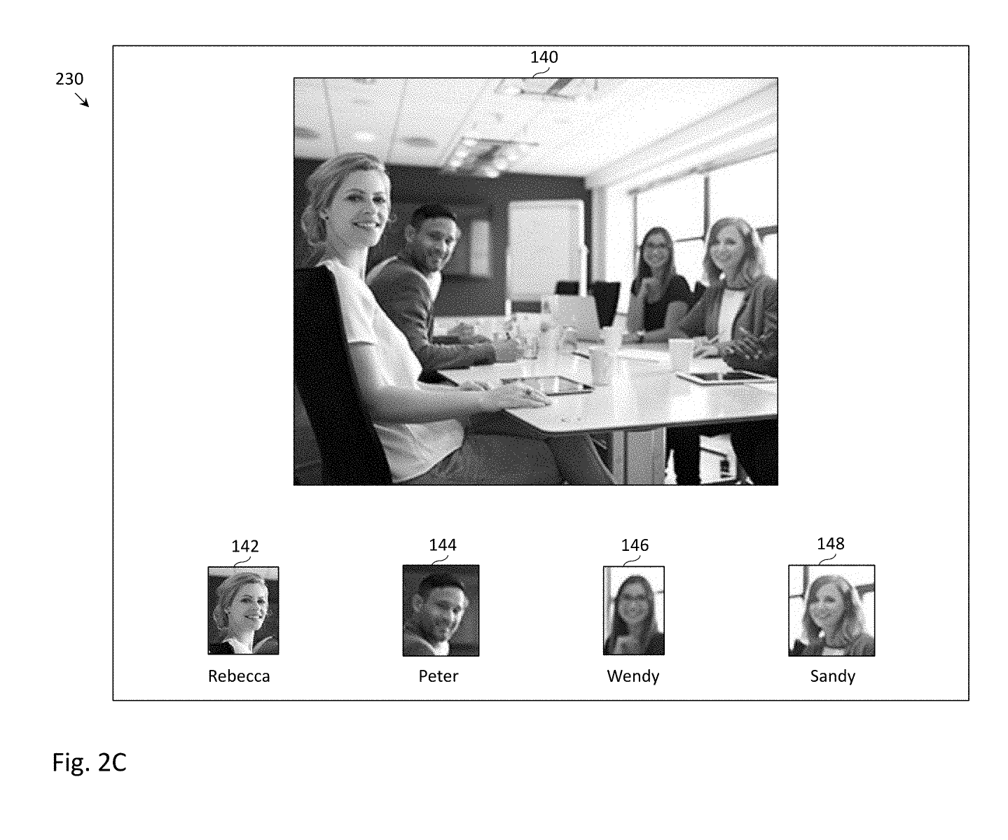

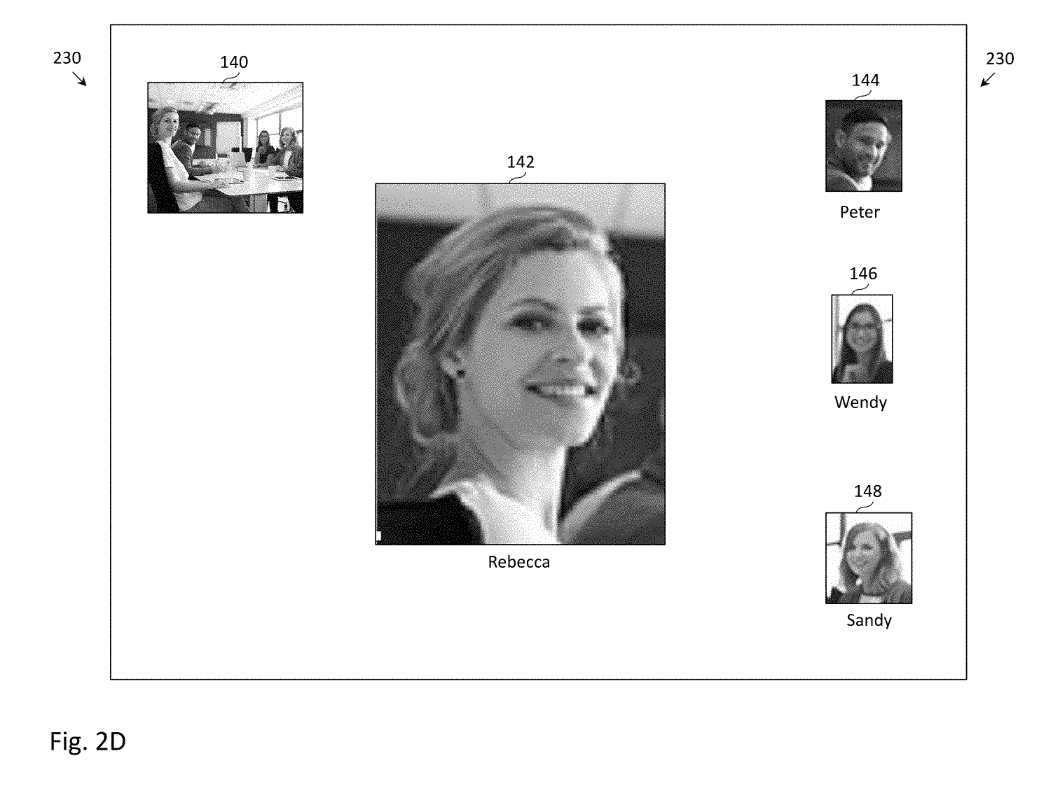

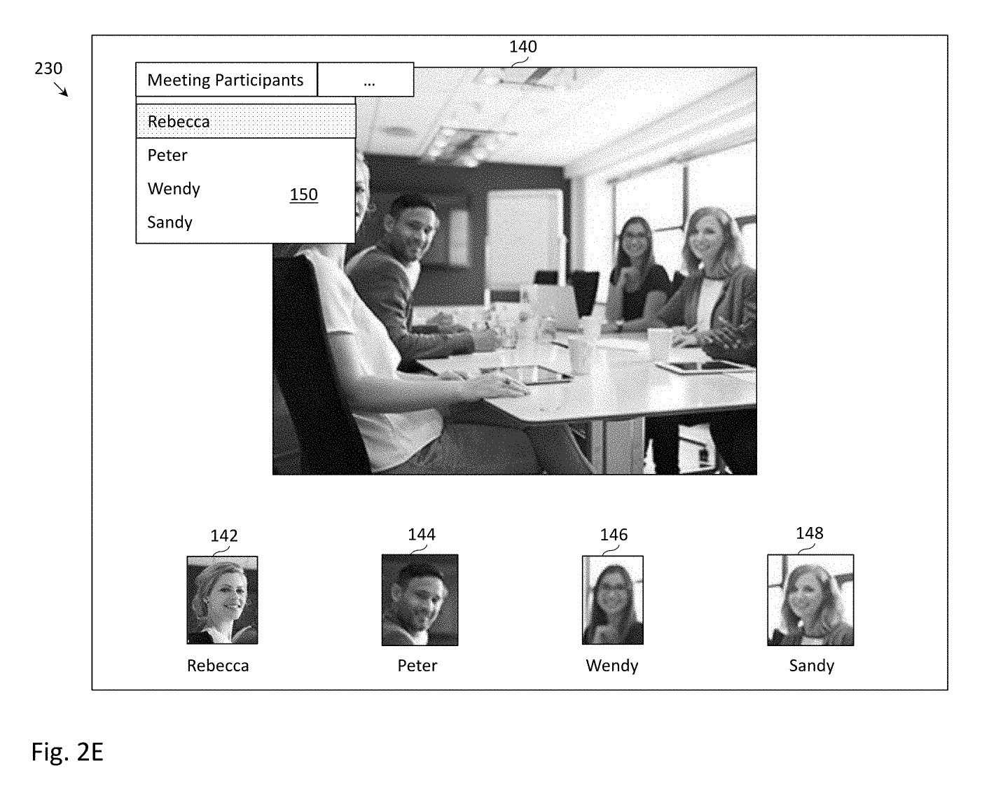

FIG. 2A depicts a system diagram of video conference system 200 with video decomposition system 206, in accordance with one embodiment of the invention. Video decomposition system 206 is similar to video decomposition system 106 depicted in FIG. 1A, except that it contains face recognizer 210, instead of face detector 110. Face recognizer 210 can not only detect a location of a face in the room video stream, but can also recognize the face as belonging to a named individual. For such facial recognition to operate successfully (and further to operate efficiently), a face profile (e.g., specific characterizing attributes of a face) may be compiled and stored (e.g., at face recognizer 210, or a database accessible by face recognizer 210) for each of the participants of room video conference endpoint 102. For instance, at some time prior to the start of the video conference, participants of room video conference endpoint 102 may provide his/her name and one or more images of his/her face to his/her own client device 116 (e.g., as part of a log-in process to client device 116). Such face profiles may be provided to face recognizer 210 (e.g., via MFU 114) and used by face recognizer 210 to recognize participants who are captured in a room video stream. For completeness, it is noted that a face profile may also be referred to as a face print or facial biometric information. The recognition accuracy may be improved (and further, the recognition response time may be decreased) if face recognizer 210 is provided with a list of the names of the participants at room video conference endpoint 102 prior to the recognition process. Face recognizer 210 may be a cloud service (e.g., a Microsoft face recognition service, Amazon Rekognition, etc.) or a native library configured to recognize faces. Specific facial recognition algorithms are known in the art and will not be discussed herein for conciseness.

Face recognizer 210 may provide video decomposer 212 with a location stream of each of the faces in the room video stream, and associate each of the location streams with a user identity (e.g., name) of the individual whose face is tracked in the location stream. The operation of video decomposer 212 may be similar to video decomposer 112, except that in addition to generating a plurality of face streams, video decomposer 212 may tag each of the face streams with an identity of the individual featured in the face stream (i.e., such identity provided by face recognizer 210).

Example output from face recognizer 210 is provided below for a specific frame:

```
{
      “frameTimestamp”: “00:17:20.7990000”,
      “faces”: [
            {
                  “id”: 123,
                  “name”: “Navneet”
                  “confidence”: 90,
                  “faceRectangle”: {
                        “width”: 78,
                        “height”: 78,
                        “left”: 394,
                        “top”: 54
                  }
            },
            {
                  “id”: 124,
                  “name”: “Ashish”
                  “confidence”: 80,
                  “faceRectangle”: {
                        “width”: 120,
                        “height”: 110,
                        “left”: 600,
                        “top”: 10
                  }
            }
      ],
}
```

If not already apparent, “frameTimestamp” may record a timestamp of the frame; and for each of the detected faces in the frame, “id” may record an identity of the face, “name” may record a name of a person with the face that has been detected, “confidence” may record the likelihood that the location specified by “faceRectangle” corresponds to a human face, and “faceRectangle” may record the location of the face.

FIG. 2B depicts further details of video decomposer 212, in accordance with one embodiment of the invention. As discussed above, video decomposer 212 may receive not only location streams, but location streams that are tagged with a user identity (e.g., identity metadata). For example, location stream “Location Stream of Face 1” may be tagged with “ID of User 1”. Video decomposer 212 may generate face streams which are similarly tagged with a user identity. For example, face stream “Video Stream of Face 1” may be tagged with “ID of User 1”. While not depicted, it is also possible for some location streams to not be tagged with any user identity (e.g., due to lack of facial profile for some users, etc.). In such cases, the corresponding face stream may also not be tagged with any user identity (or may be tagged as “User ID unknown”).

FIG. 2C depicts user interface 230 at client device 116 for interfacing one or more users of client device 116 with participants of room video conference endpoint 102, in accordance with one embodiment of the invention. User interface 230 of FIG. 2C is similar to user interface 130 of FIG. 1C, except that the rendered face streams are labeled with the identity of the individual captured in the face stream (i.e., such identities provided by face recognizer 210). For example, rendered face stream 142 is labeled with the name “Rebecca”; rendered face stream 144 is labeled with the name “Peter”; rendered face stream 146 is labeled with the name “Wendy”; and rendered face stream 148 is labeled with the name “Sandy”. Upon selection of one of the individuals, user interface 230 can transition from a “Room FullView” mode to a “Room SplitView” mode (depicted in FIG. 2D). FIG. 2D is similar to FIG. 1D, except that the face streams are labeled with the identity of the individual captured in the face stream. FIG. 2E depicts drop-down menu 150 which may be another means for selecting one of the participants of room video conference endpoint 102. In the example of FIG. 2E, drop-down menu 150 is used to select Rebecca. In response to such selection, user interface 230 may transition from the “Room FullView” of FIG. 2E to the “Room SplitView of FIG. 2D.

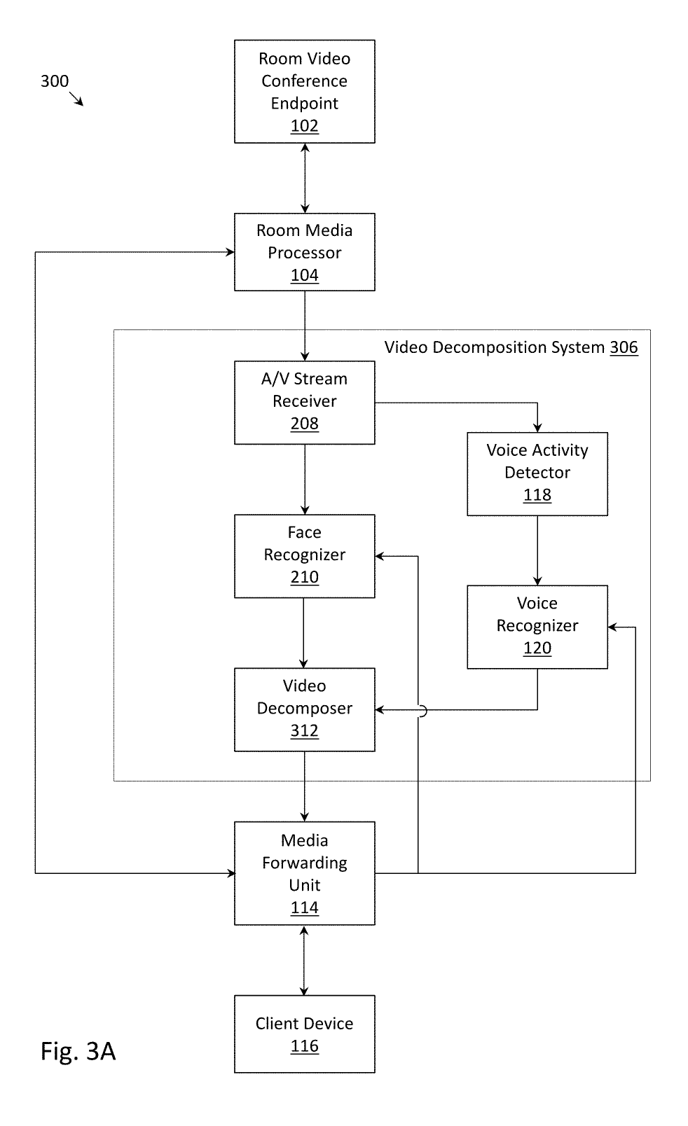

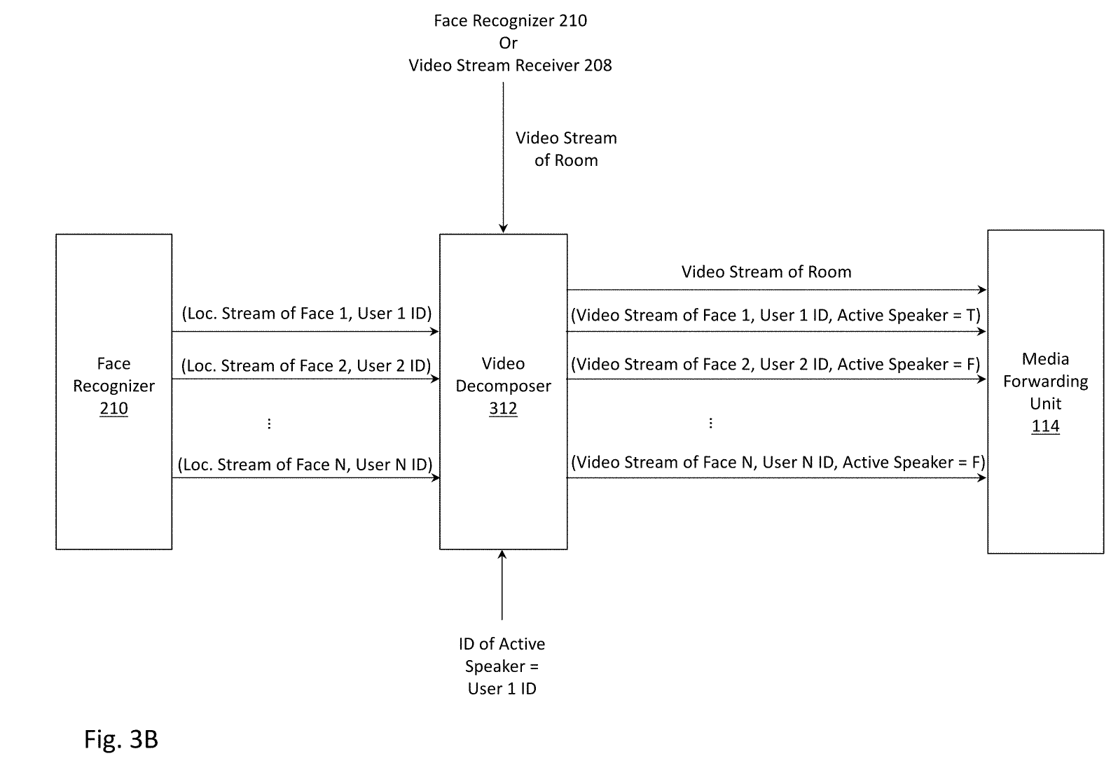

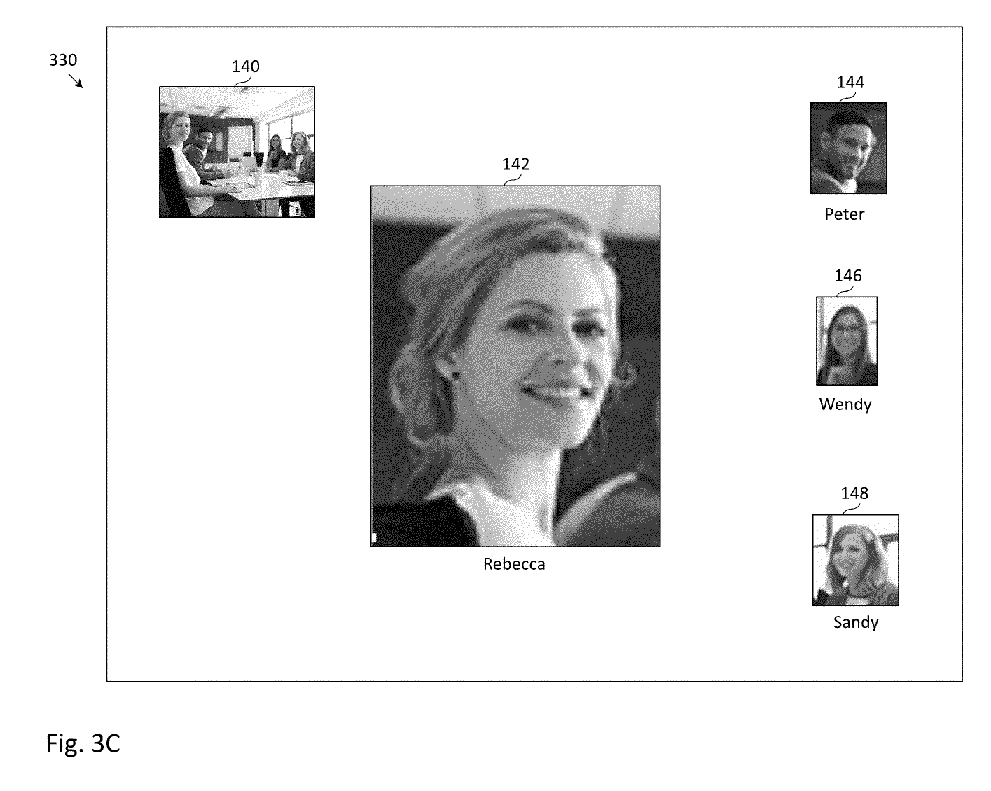

FIG. 3A depicts a system diagram of video conference system 300 with video decomposition system 306, in accordance with one embodiment of the invention. Video decomposition system 306 is similar to video decomposition system 206, except that it contains additional components for detecting the active speaker (e.g., voice activity detector (VAD) 118 and voice recognizer 120). VAD 118 may receive the audio stream (i.e., audio stream portion of the A/V stream from room video conference endpoint 102) from A/V stream receiver 208, and classify portions of the audio stream as speech or non-speech. Specific techniques to perform voice activity detection (e.g., spectral subtraction, comparing envelope to threshold, etc.) are known in the art and will not be discussed herein for conciseness. Speech portions of the audio stream may be forwarded from VAD 118 to voice recognizer 120.

Voice recognizer 120 (or also called “speaker recognizer” 120) may recognize the identity of the speaker of the audio stream. For such voice recognition to operate successfully (and further to operate efficiently), a voice profile (e.g., specific characterizing attributes of a participant's voice) may be compiled and stored (e.g., at voice recognizer 120 or a database accessible to voice recognizer 120) for each of the participants of room video conference endpoint 102 prior to the start of the video conference. For example, samples of a participant's voice/speech may be tagged with his/her name to form a voice profile. Such voice profiles may be provided to voice recognizer 120 (e.g., via MFU 114) and used by voice recognizer 120 to recognize the identity of the participant who is speaking (i.e., the identity of the active speaker). For completeness, it is noted that a voice profile may also be referred to as a voice print or vocal biometric information. The recognition accuracy may be improved (and further, the recognition response time may be decreased) if voice recognizer 120 is provided with a list of the names of the participants at room video conference endpoint 102 prior to the recognition process. Voice recognizer 120 may be a cloud service (e.g., a Microsoft speaker recognition service) or a native library configured to recognize voices. Specific voice recognition algorithms are known in the art and will not be discussed herein for conciseness.

The identity of the active speaker may be provided by voice recognizer 120 to video decomposer 312. In many instances, the user identity associated with one of the face streams generated by video decomposer 312 will match the identity of the active speaker, since it is typical that one of the recognized faces will correspond to the active speaker. In these instances, video decomposer 312 may further label the matching face stream as the active speaker. There may, however, be other instances in which the identity of the active speaker will not match any of the user identities associated with the face streams. For instance, the active speaker may be situated in a dimly lit part of the room. While his/her voice can be recognized by voice recognizer 120, his/her face cannot be recognized by face recognizer 210, resulting in none of the face streams corresponding to the active speaker. In these instances, none of the face streams will be labeled as the active speaker.

FIG. 3B depicts further details of video decomposer 312, in accordance with one embodiment of the invention. As described above, video decomposer 312 may receive the identity of the active speaker from voice recognizer 120. Video decomposer 312 may additionally receive location streams paired with the corresponding identity of the user tracked by the location stream from face recognizer 210. In the example of FIG. 3B, the identity of the active speaker matches the identity paired with the location stream of Face 1. Based on this match, the face stream of Face 1 is tagged as corresponding to the active speaker (e.g., Active Speaker=T). Optionally, the remaining face streams may be tagged as not corresponding to the active speaker (e.g., Active Speaker=F).

FIG. 3C depicts user interface 330 at client device 116 for interfacing one or more users of client device 116 with participants of room video conference endpoint 102, in accordance with one embodiment of the invention. User interface 330 of FIG. 3C is in a “Room SplitView” mode and in contrast to the “Room SplitView” modes described in FIGS. 1C and 2C, the “Room SplitView” mode may automatically be featured in user interface 330 of FIG. 3C without the user of client device 116 selecting a participant of room video conference endpoint 102. The face stream that is automatically displayed in a prominent fashion in FIG. 3C, as compared to the other face streams, may be the face stream corresponding to the active speaker. The example of FIG. 3C continues from the example of FIG. 3B. Since the active speaker was identified to be “ID of User 1” in FIG. 3B, User 1 (corresponding to “Rebecca”) may be automatically displayed in a prominent fashion in FIG. 3C. The rendered face streams may further be labeled in FIG. 3C with the respective user identities (since these identities were provided by video decomposer 312 for each of the face streams). At a later point in time, if User 2 becomes the active speaker, user interface 330 may automatically interchange the locations at which the face stream of User 2 and User 1 are rendered (not depicted).

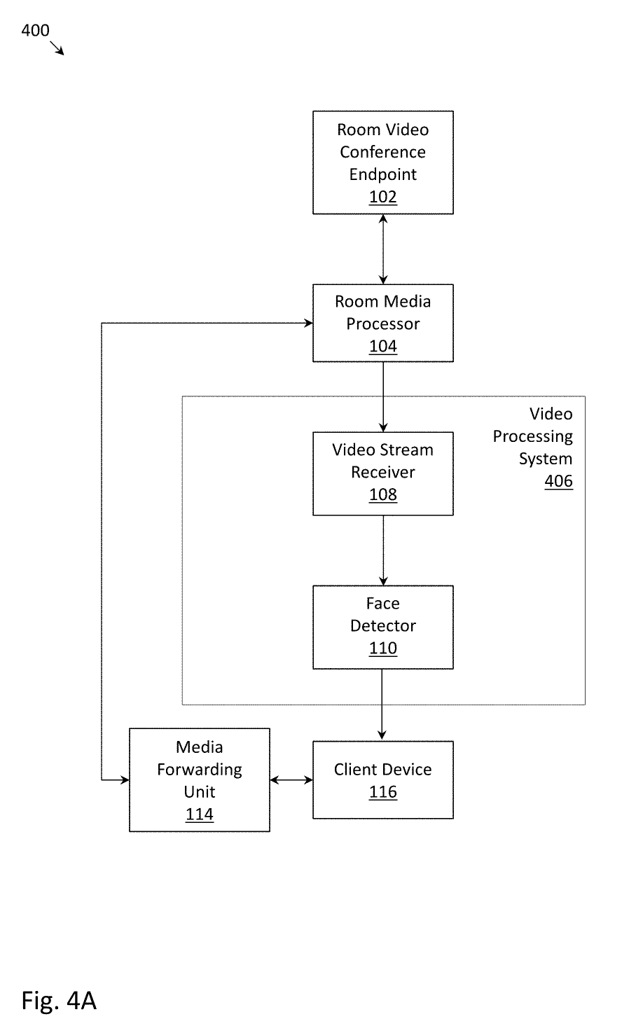

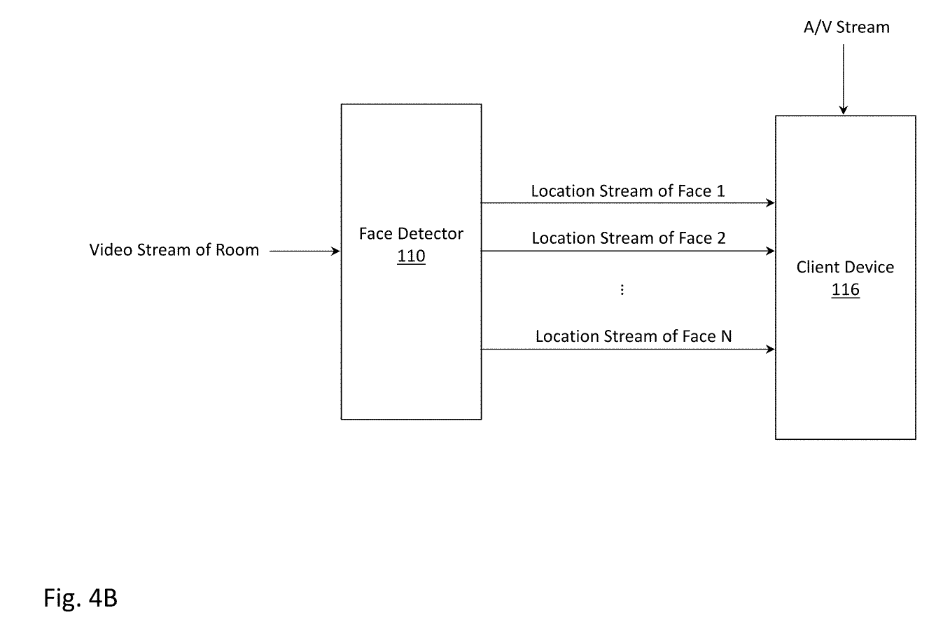

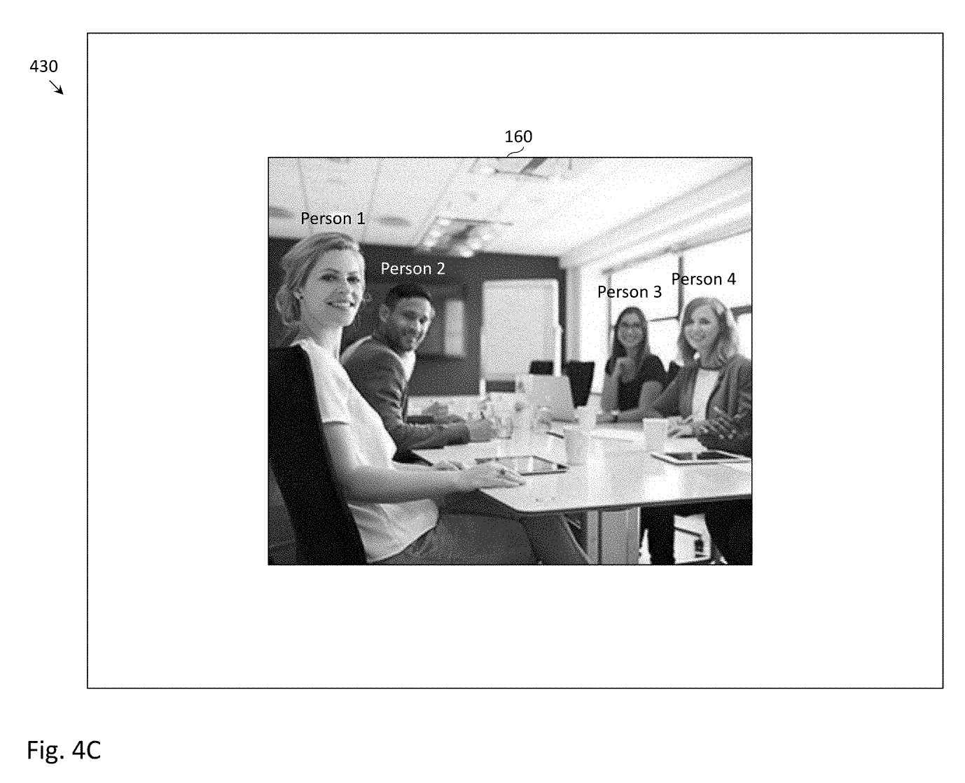

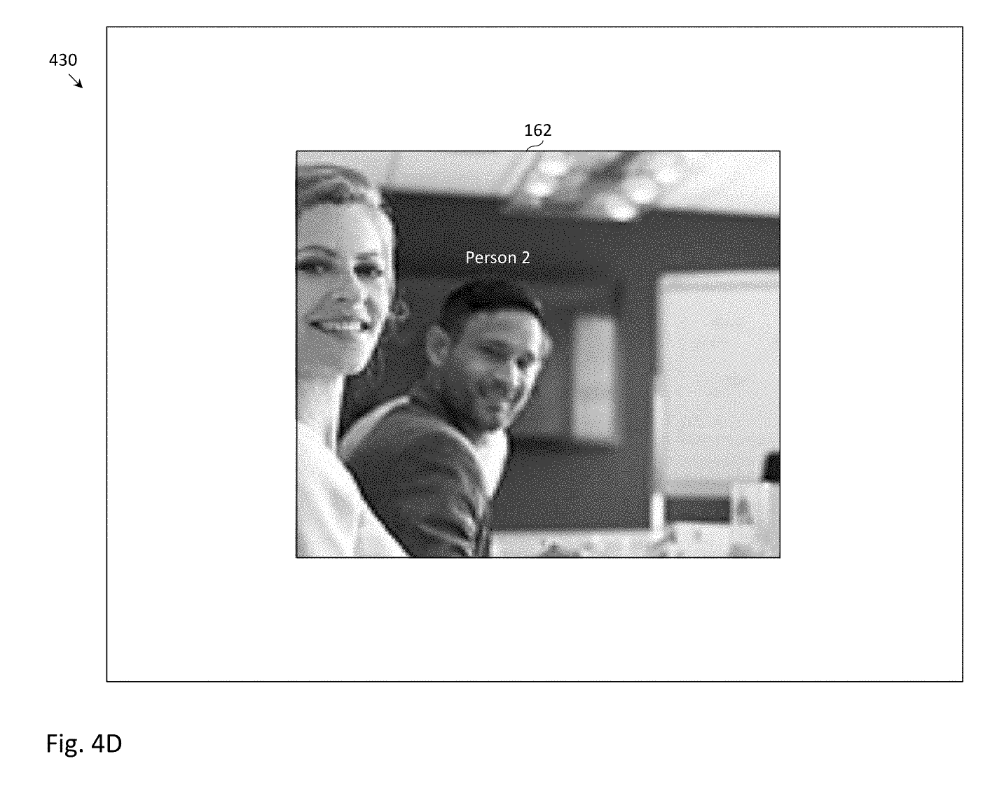

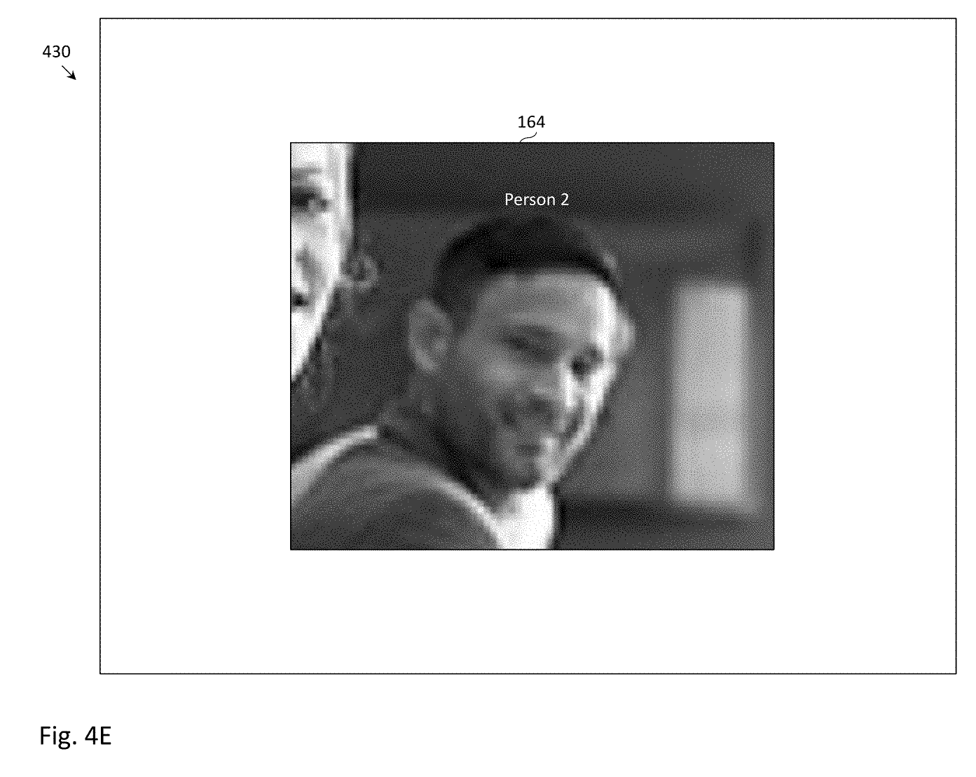

FIG. 4A depicts a system diagram of video conference system 400 with video processing system 406, in accordance with one embodiment of the invention. Video conference system 400 has some similarities with video conference system 100 in that both include face detector 110 to identify the location of faces. These systems are different, however, in that the output of face detector 110 is provided to video decomposer 112 in video conference system 100, whereas the output of face detector 110 is provided to client device 116 in video conference system 400. As described above, the output of face detector 110 may include the location stream of each of the faces, and possibly include a confidence value associated with each of the face location estimates. In addition to the location stream, client device 116 may receive the A/V stream from MFU 114. Client device 116 may display a user interface within which the room video stream is rendered, and based on the location streams may label a location of each of the faces in the rendered room video stream. In addition, the location streams may allow the user of client device 116 to zoom in and pan to any one of the individuals captured in the room video stream. Such functionality of the user interface is described in more detail in FIGS. 4C-4E below.

FIG. 4B depicts further details of face detector 110 and client device 116 depicted in FIG. 4A, in accordance with one embodiment of the invention. As explained above, face detector 110 may generate a location stream for each of the faces detected in the room video stream, and provide such location streams to client device 116. In addition, client device 116 may receive the A/V stream captured by room video conference endpoint 102 (e.g., from MFU 114).

FIGS. 4C-4E depict user interface 430 at client device 116 for interfacing one or more users of client device 116 with participants of room video conference endpoint 102, in accordance with one embodiment of the invention. FIG. 4C depicts user interface 430 in which room video stream may be rendered (a rendered frame of the room video stream has been labeled as 160). Based on the location streams received, client device 116 can also label the location of each of the detected faces in the rendered version of the room video stream. In the example user interface of FIG. 4C, the detected faces have been labeled as “Person 1”, “Person 2”, “Person 3” and Person 4”. By selecting one of the labeled faces (e.g., using a cursor controlling device to “click” on one of the individuals in rendered frame 160), a user of client device 116 can request client device 116 to pan and zoom into the selected individual. Panning to the selected individual may refer to a succession of rendered frames in which the selected individual is initially rendered at an off-center location but with each successive frame is rendered in a more-central location before eventually being rendered at a central location. Such panning may be accomplished using signal processing techniques (e.g., a digital pan). Zooming into the selected individual may refer to a succession of rendered frames in which the selected individual is rendered with successively more pixels of the display of client device 116. Such zooming may be accomplished using signal processing techniques (e.g., a digital zoom). If room video conference endpoint 102 were equipped with a pan-tilt-zoom (PTZ) enabled camera, room video conference endpoint 102 can also use optical zooming and panning so that client device 116 can get a better resolution of the selected individual.

The user interface depicted in FIGS. 4C-4E illustrates the rendering of the room video stream, in which the rendering exhibits a zooming and panning into “Person 2”. One can notice how the face of Person 2 is initially located on a left side of rendered frame 160, is more centered in rendered frame 162, before being completely centered in rendered frame 164. Also, one can also notice how the face of Person 2 initially is rendered with a relatively small number of pixels in rendered frame 160, more pixels in rendered frame 162, and even more pixels in rendered frame 164.

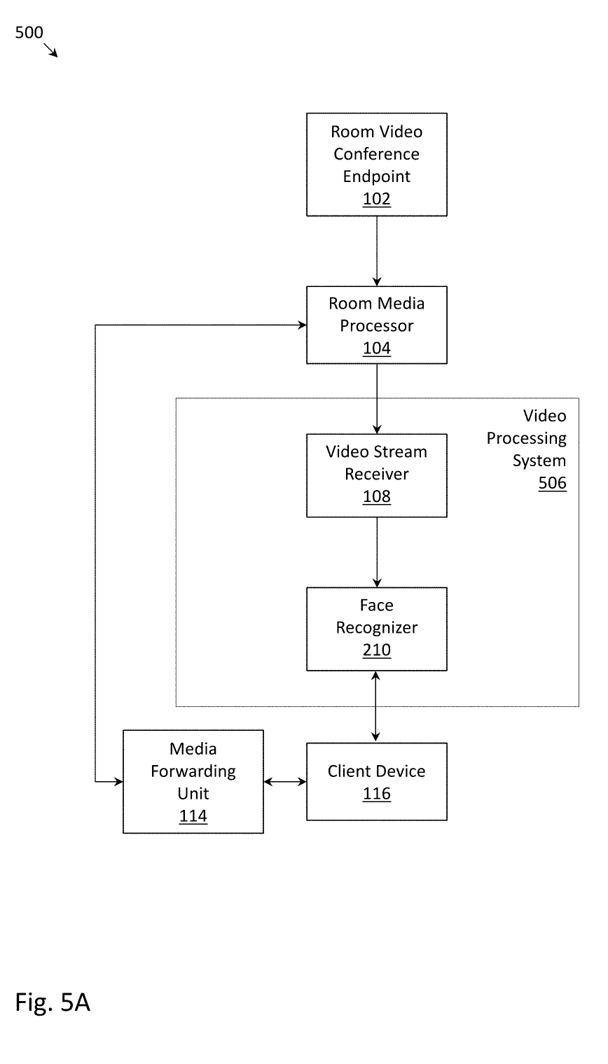

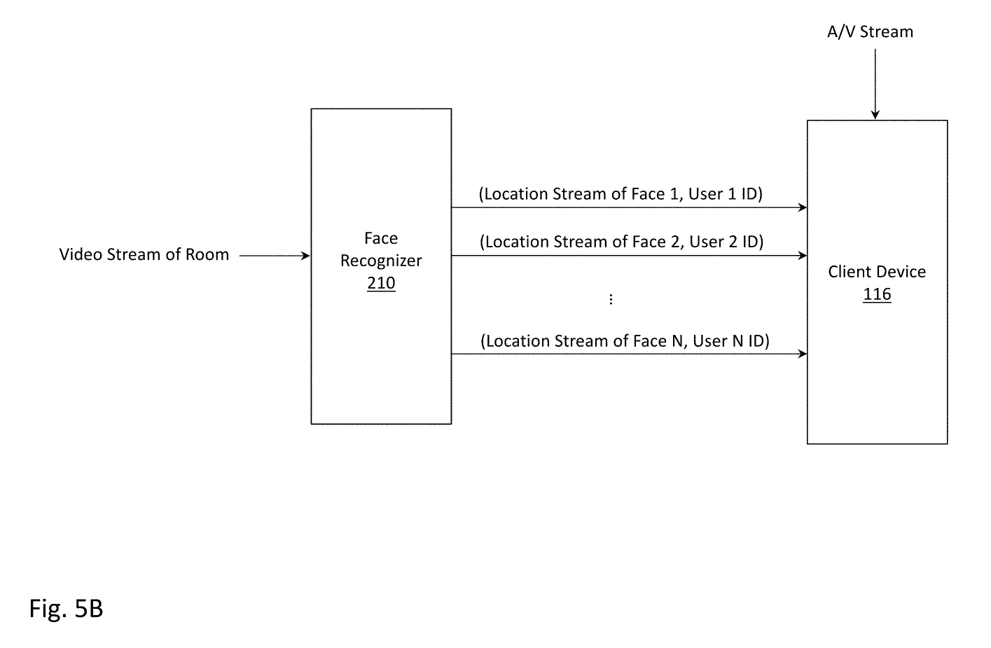

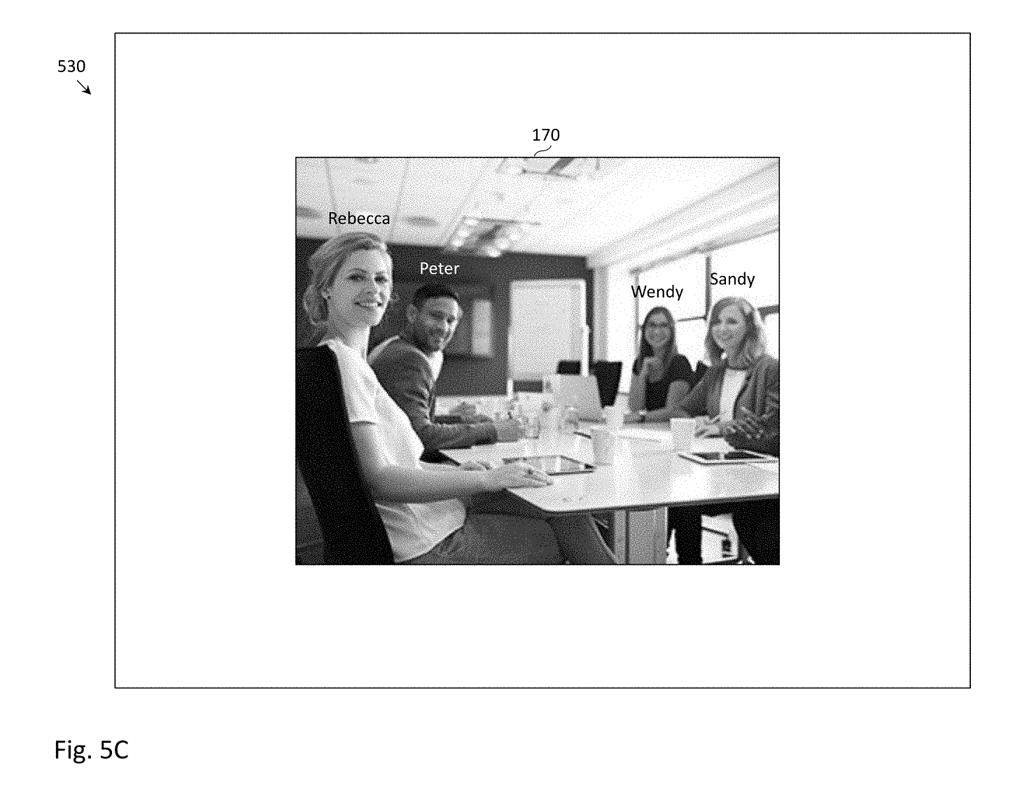

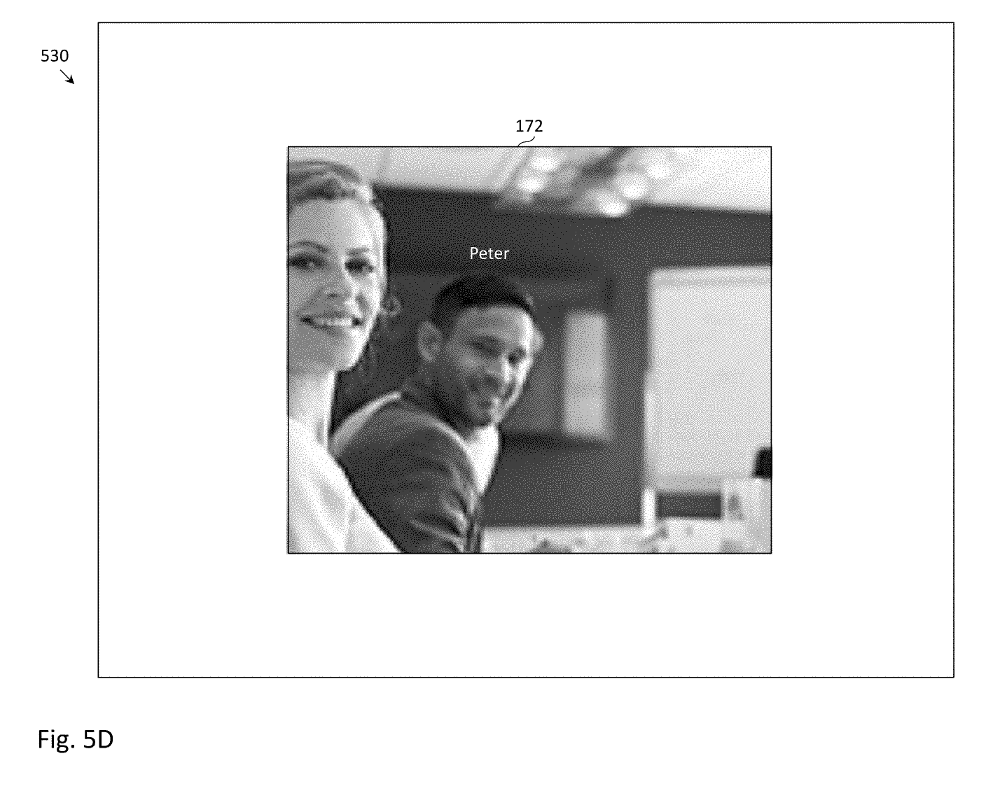

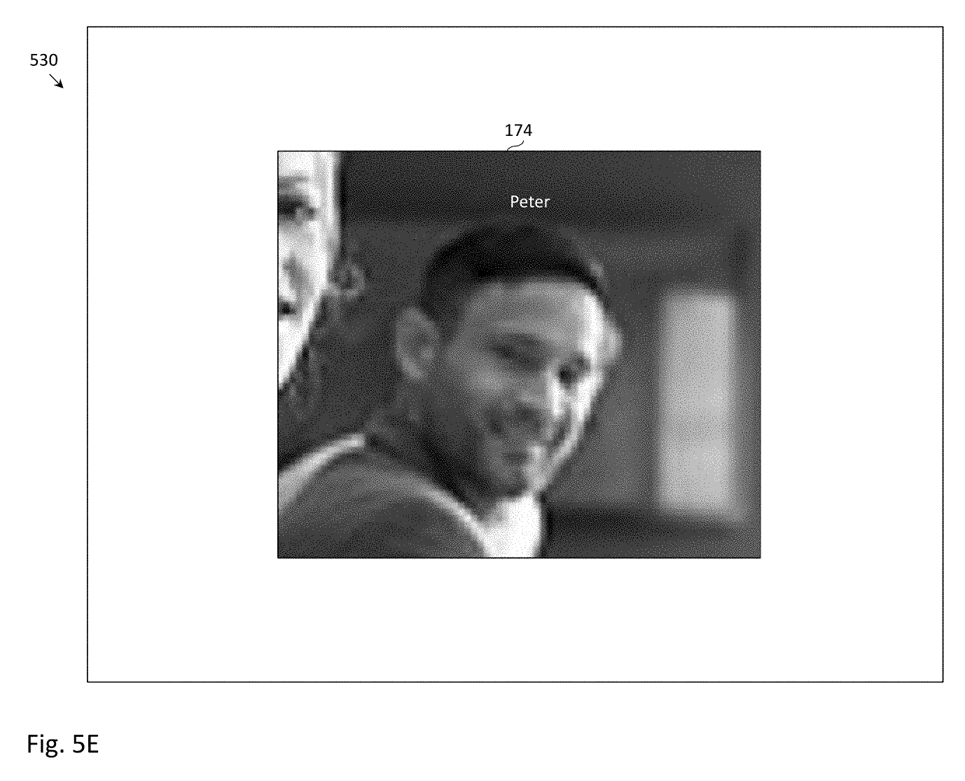

FIG. 5A depicts a system diagram of video conference system 500 with video processing system 506, in accordance with one embodiment of the invention. Video conference system 500 has some similarities with video conference system 200 in that both include recognizer 210 to identify the location of faces. These systems are different, however, in that the output of face recognizer 210 is provided to video decomposer 212 in video conference system 200, whereas the output of face recognizer 210 is provided to client device 116 in video conference system 500. As described above, the output of face recognizer 210 may include the location stream for each of the faces detected in the room video stream, and for each of the location streams, the output of face recognizer 210 may include user identity (e.g., name) of the individual whose face is tracked in the location stream as well as any confidence value for location estimates. In addition to the location stream (and other input from face recognizer 210), client device 116 may receive the A/V stream from MFU 114. Client device 116 may display a user interface within which the room video stream is rendered, and based on the location streams associated with respective participants' identities, may label each of the faces in the rendered room video stream with the corresponding participant identity. In addition, the location streams may allow the user of client device 116 to zoom in and pan to any one of the individuals captured in the room video stream. Such functionality of the user interface is described in more detail in FIGS. 5C-5E below.

FIG. 5B depicts further details of face recognizer 210 and client device 116 depicted in FIG. 5A, in accordance with one embodiment of the invention. As explained above, face recognizer 210 may generate a location stream for each of the detected faces, and provide such location streams, together with an identity of the user captured in the respective location stream, to client device 116. In addition, client device 116 may receive the A/V stream captured by room video conference endpoint 102.

FIGS. 5C-5E depict user interface 530 at client device 116 for interfacing one or more users of client device 116 with participants of room video conference endpoint 102, in accordance with one embodiment of the invention. FIG. 5C depicts user interface 530 in which a room video stream may be rendered (a rendered frame of the room video stream has been labeled as 170). Based on the location streams received, client device 116 can label each of the detected faces in the rendered version of the room video stream with the name of the person to which the detected face belongs. In the example user interface of FIG. 5C, the detected faces have been labeled as “Rebecca”, “Peter”, “Wendy” and “Sandy”. By selecting one of the labeled faces (e.g., using a cursor controlling device to “click” on one of the individuals in rendered frame 170), a user of client device 116 can request client device 116 to pan and zoom into the selected face.

The user interface depicted in FIGS. 5C-5E illustrates the rendering of the room video stream, in which the rendering exhibits a zooming and panning into “Peter”. One can notice how the face of Peter is initially located on a left side of rendered frame 170, is more centered in rendered frame 172, before being completed centered in rendered frame 174. Also, one can also notice how the face of Peter initially is rendered with a relatively small number of pixels in rendered frame 170, more pixels in rendered frame 172, and even more pixels in rendered frame 174.

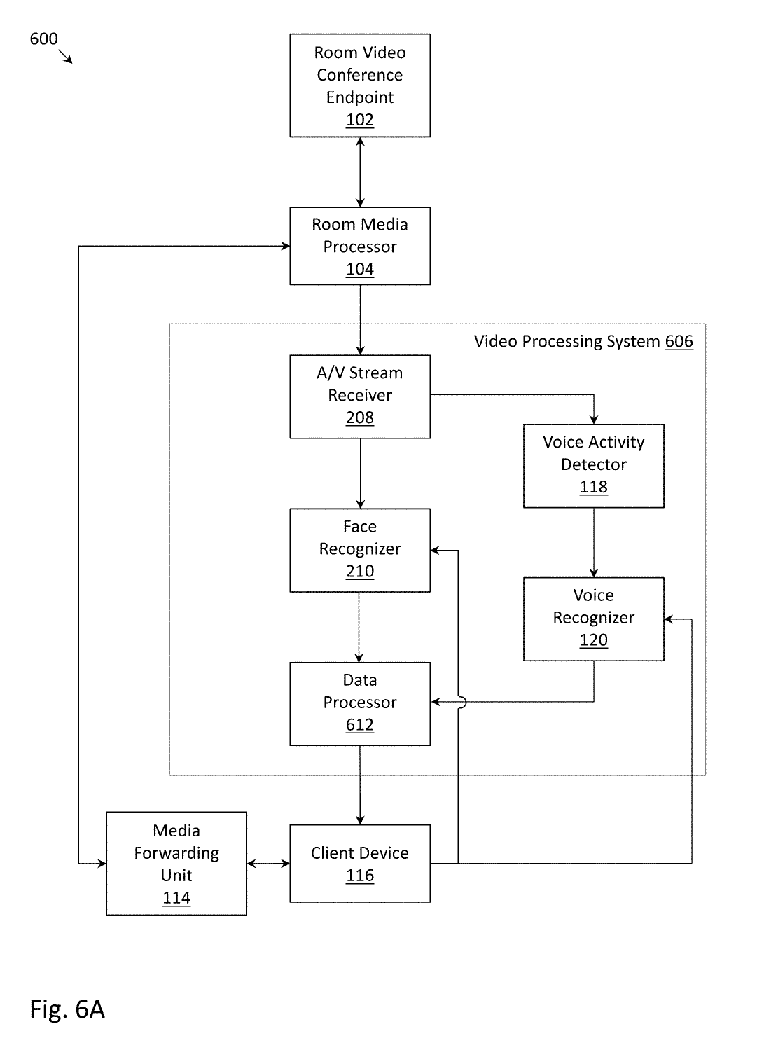

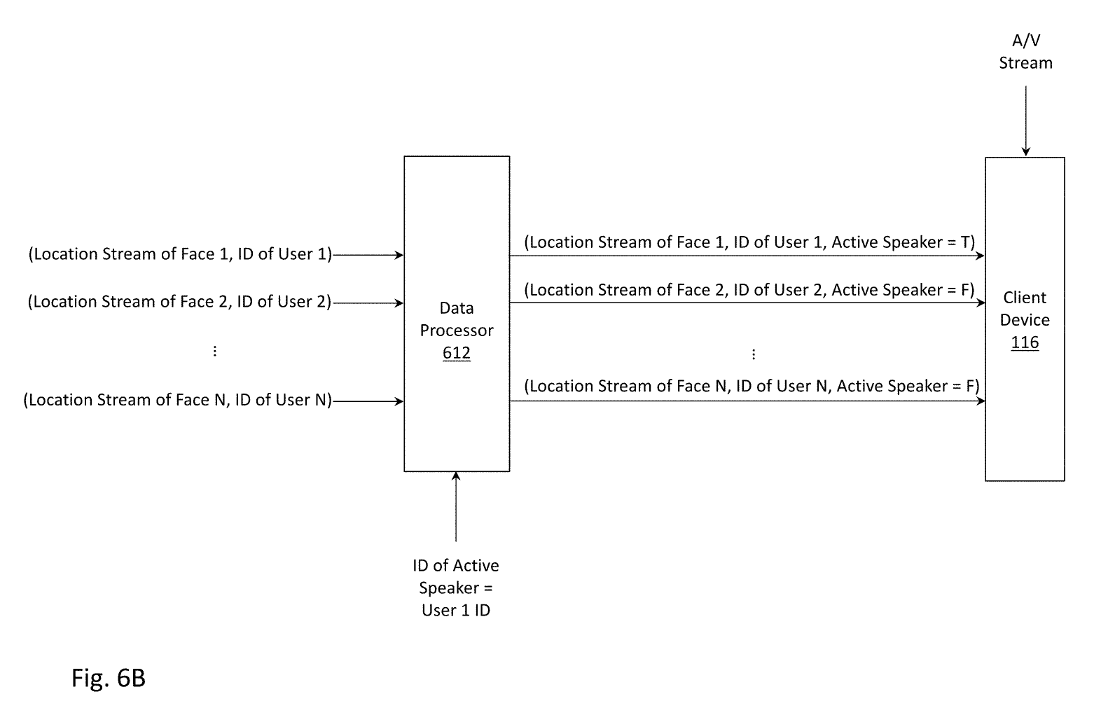

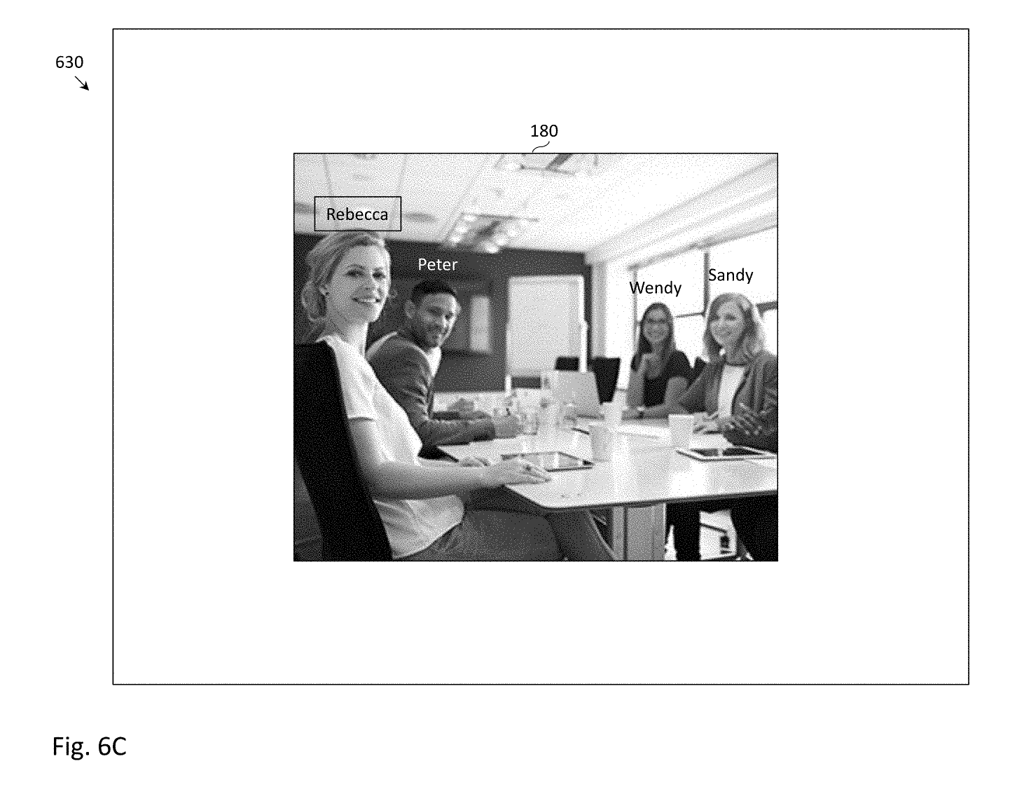

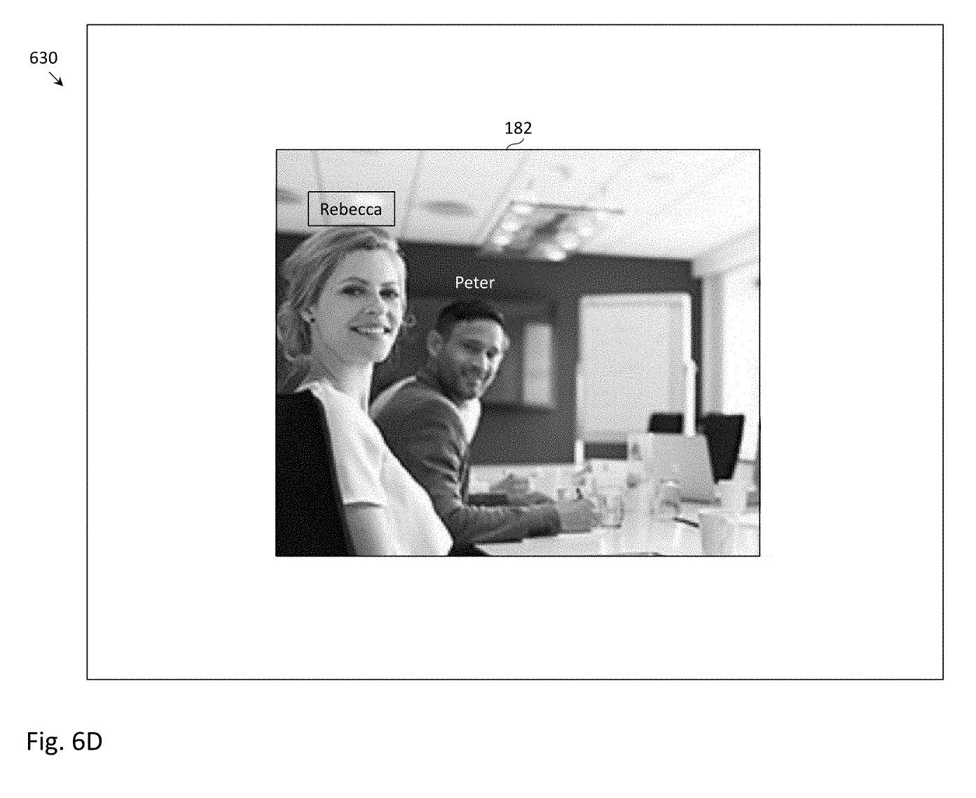

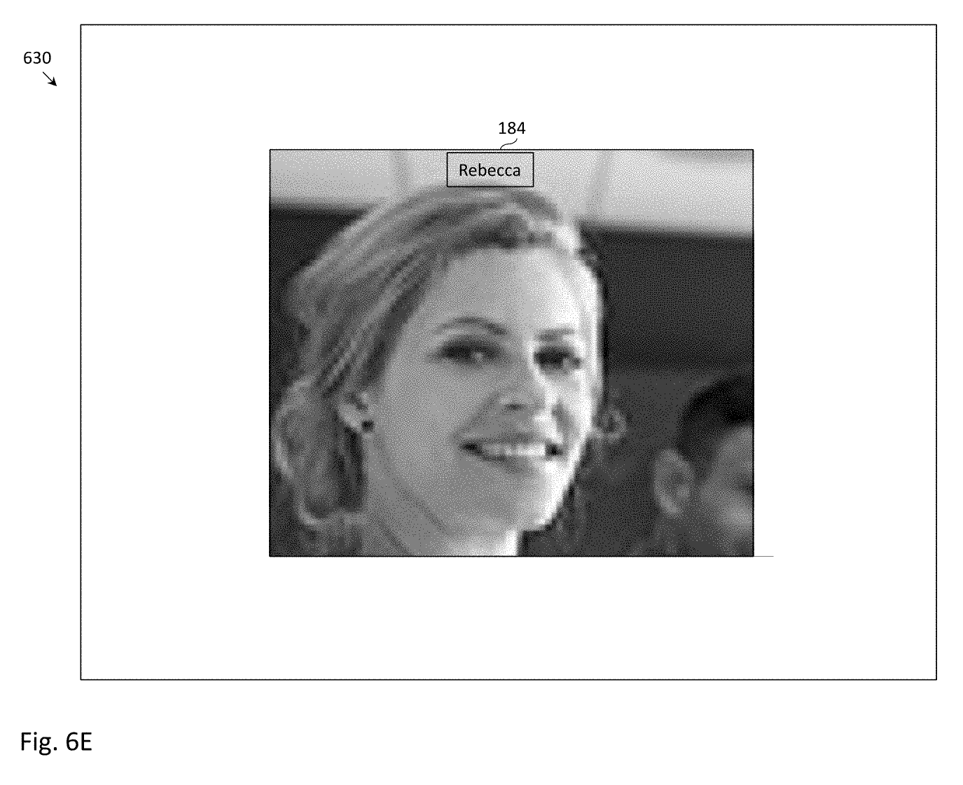

FIG. 6A depicts a system diagram of video conference system 600 with video processing system 606, in accordance with one embodiment of the invention. Video conference system 600 has some similarities with video conference system 300 in that both determine an identity of the active speaker using VAD 118 and voice recognizer 120. These systems are different, however, in that the output of face recognizer 210 is provided to video decomposer 312 in video conference system 300, whereas the output of face recognizer 210 is provided to data processor 612 in video conference system 600. Whereas video decomposer 312 may generate face streams with one of the face streams labeled as the active speaker, data processor 612 may generate location streams with one of the location streams labeled as the active speaker. In video conferencing system 600, these location streams and active speaker information may further be provided to client device 116, which may use such information to automatically pan and zoom into the active speaker in a rendered version of the room video stream. There may, however, be other instances in which the identity of the active speaker will not match any of the user identities associated with the location streams. For instance, the active speaker may be situated in a dimly lit part of the room or may be in a part of the room not visible to the video camera. While his/her voice can be recognized by voice recognizer 120, his/her face cannot be recognized by face recognizer 210, resulting in none of the location streams corresponding to the active speaker. In these instances, none of the location streams will be labeled as the active speaker.

FIG. 6B depicts further details of data processor 612 and client device 116 depicted in FIG. 6A, in accordance with one embodiment of the invention. Data processor 612 may receive the identity of the active speaker from voice recognizer 120. Data processor 612 may additionally receive location streams paired with the corresponding identity of the user tracked by the location stream from face recognizer 210. In the example of FIG. 6B, the identity of the active speaker matches the identity paired with the location stream of Face 1. Based on this match, the location stream of Face 1 may be tagged, by data processor 612, as corresponding to the active speaker (e.g., Active Speaker=T). Optionally, the remaining location streams may be tagged as not corresponding to the active speaker (e.g., Active Speaker=F). The location streams with their associated metadata may be provided to client device 116. In addition, client device 116 may receive the A/V stream captured by room video conference endpoint 102 (e.g., from MFU 114).

Example output from data processor 612 is provided below for a specific frame:

```
{
      ″frameTimestamp″: ″00:17:20.7990000″,
      ″faces″: [
            {
                  ″id″: 123,
                  ″name″: ″Navneet″
                  ″confidence″: 90,
                  ″faceRectangle″: {
                        ″width″: 78,
                        ″height″: 78,
                        ″left″: 394,
                        ″top″: 54
                  }
            },
            {
                  ″id″: 124,
                  ″name″: ″Ashish″
                  ″confidence″: 80,
                  ″faceRectangle″: {
                        ″width″: 120,
                        ″height″: 110,
                        ″left″: 600,
                        ″top″: 10
                  }
            }
      ],
      “activeSpeakerId”: 123
}
```

If not already apparent, “frameTimestamp” may record a timestamp of the frame, and for each of the detected faces in the frame, “id” may record an identity of the face, “name” may record a name of a person with the face that has been detected, “confidence” may record the likelihood that the location specified by “faceRectangle” corresponds to a human face, and “faceRectangle” may record the location of the face. In addition, “activeSpeakerId” may label one of the detected faces as the active speaker. In the current example, the face with id=123 and name=Navneet has been labeled as the active speaker.

FIGS. 6C-6E depict user interface 630 at client device 116 for interfacing one or more users of client device 116 with participants of room video conference endpoint 102, in accordance with one embodiment of the invention. FIG. 6C depicts user interface 630 in which a room video stream may be rendered (a rendered frame of the room video stream has been labeled as 180). Based on the location streams received, client device 116 can label each of the detected faces in the rendered version of the room video stream with the name of the person to which the detected face belongs. In the example user interface of FIG. 6C, the detected faces have been labeled as “Rebecca”, “Peter”, “Wendy” and “Sandy”. Based on the identity of the active speaker provided by data processor 612, client device 116 can further label the active speaker. In the example of FIG. 6C, a rectangle is used to indicate that Rebecca is the active speaker. There are, however, many other ways in which the active speaker could be indicated. For example, a relative brightness could be used to highlight the active speaker from the other participants; an arrow may be displayed on the user interface that points to the active speaker; a “Now Speaking: <name of active speaker>” cue could be presented; etc.

The user interface depicted in FIGS. 6C-6E further illustrates a rendering of the room video stream, in which the rendering automatically zooms and pans into the face of the active speaker, in this case “Rebecca”. One can notice how the face of Rebecca is initially located on a left side of rendered frame 180, is more centered in rendered frame 182, before being completed centered in rendered frame 184. Also, one can also notice how the face of Rebecca initially is rendered with a relatively small number of pixels in rendered frame 180, more pixels in rendered frame 182, and even more pixels in rendered frame 184.

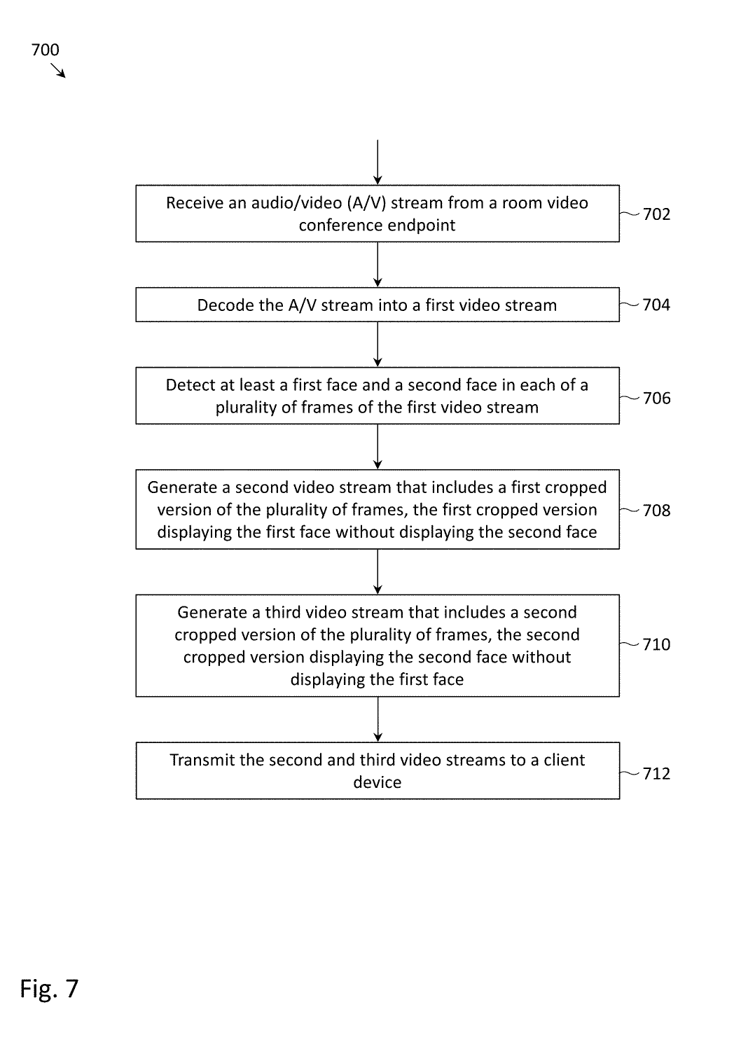

FIG. 7 depicts flow diagram 700 of a process for decomposing a first video stream into a second and third video stream, in accordance with one embodiment of the invention. At step 702, room media processor 104 may receive an A/V stream from room video conference endpoint 102. At step 704, room media processor 104 may decode the A/V stream into a first video stream and optionally a first audio stream. At step 706, face detector 110 may detect at least a first face and a second face in each of a plurality of frames of the first video stream. At step 708, video decomposer 112 may generate a second video stream that includes a first cropped version of the plurality of frames, the first cropped version displaying the first face without displaying the second face. The first cropped version of the plurality of frames may be generated based on information indicating a location of the first face in each of the plurality of frames of the first video stream. At step 710, video decomposer 112 may generate a third video stream that includes a second cropped version of the plurality of frames, the second cropped version displaying the second face without displaying the first face. The second cropped version of the plurality of frames may be generated based on information indicating a location of the second face in each of the plurality of frames of the first video stream. At step 712, video decomposer 112 may transmit the second and third video streams to client device 116 (e.g., via MFU 114).

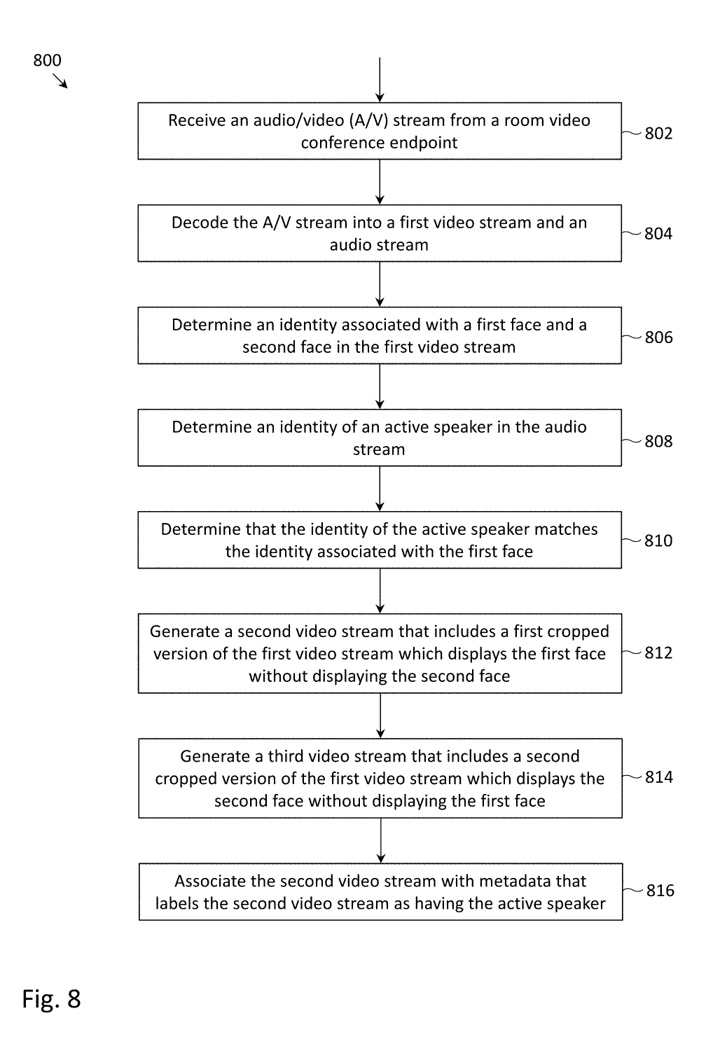

FIG. 8 depicts flow diagram 800 of a process for decomposing a first video stream (also called a “source video stream”) into a second and third video stream and labeling one of the decomposed video streams as containing an active speaker, in accordance with one embodiment of the invention. At step 802, room media processor 104 may receive an A/V stream from room video conference endpoint 102. At step 804, room media processor 104 may decode the A/V stream into a first video stream and an audio stream. At step 806, face recognizer 210 may determine an identity associated with a first face and a second face in the first video stream. At step 808, voice recognizer 120 may determine an identity of an active speaker in the audio stream. At step 810, video decomposer 312 may determine that the identity of the active speaker matches the identity associated with the first face. At step 812, video decomposer 312 may generate a second video stream that includes a first cropped version of the first video stream which displays the first face without displaying the second face. The first cropped version of the first video stream may be generated based on information indicating locations of the first face in the first video stream. At step 814, video decomposer 312 may generate a third video stream that includes a second cropped version of the first video stream which displays the second face without displaying the first face. The second cropped version of the first video stream may be generated based on information indicating locations of the second face in the first video stream. At step 816, video decomposer 312 may associate the second video stream with metadata that labels the second video stream as having the active speaker.

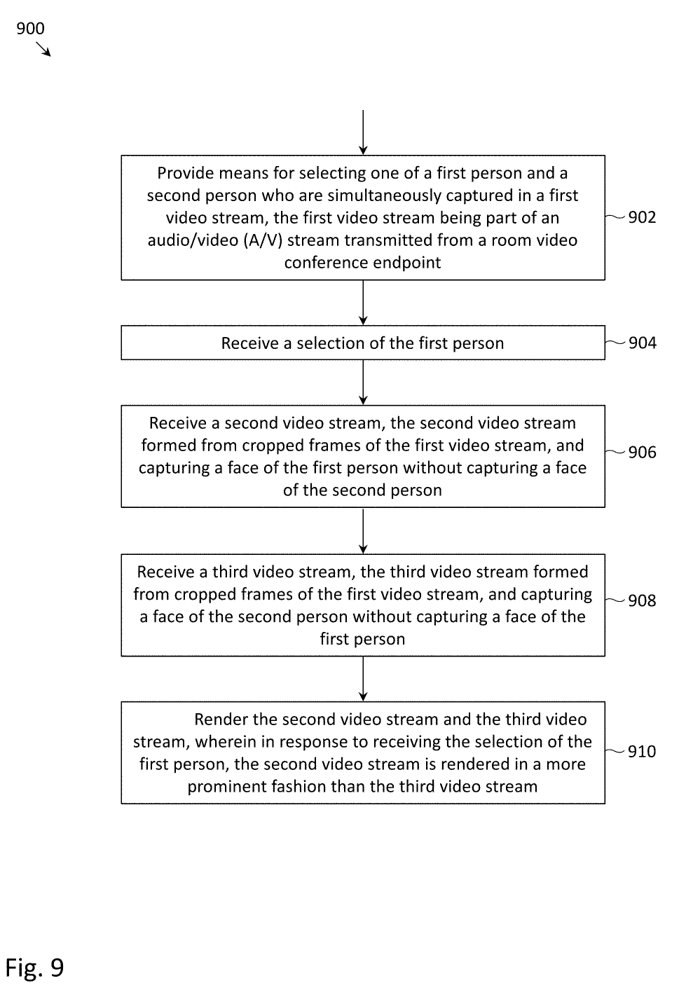

FIG. 9 depicts a flow diagram of a process for receiving a plurality of decomposed video streams, receiving a selection of one of the decomposed streams (more specifically, receiving a selection of an individual featured in one of the decomposed streams), and displaying the selected stream in a more prominent manner than the non-selected streams, in accordance with one embodiment of the invention. At step 902, client device 116 may provide a means for selecting one of a first person and a second person who are simultaneously captured in a first video stream, the first video stream being part of an A/V stream generated by room video conference endpoint 102. In one embodiment, the means for selecting one of the first person and the second person may comprise drop-down menu 150 that includes an identity of the first person and an identity of the second person. Alternatively or in addition, the means for selecting one of the first person and the second person may comprise a rendered version of the first video stream for which input directed at a region of the rendered version of the first video stream that displays the first person indicates selection of the first person and input directed at a region of the rendered version of the first video stream that displays the second person indicates selection of the second person. At step 904, client device 116 may receive a selection of the first person from a user of client device 116 (e.g., via drop-down menu 150 or the rendered version of first video stream). At step 906, client device 116 may receive from video decomposition system (106, 206 or 306) a second video stream, the second video stream formed from cropped frames of the first video stream, and capturing a face of the first person without capturing a face of the second person. At step 908, client device 116 may receive from video decomposition system (106, 206 or 306) a third video stream, the third video stream formed from cropped frames of the first video stream, and capturing a face of the second person without capturing a face of the first person. At step 910, the second video stream and the third video stream may be rendered on a display of client device 116. In response to receiving the selection of the first person, the second video stream may be rendered in a more prominent fashion than the third video stream. For example, the rendered second video stream may occupy a larger area of the display than the rendered third video stream. As another example, the second video stream may be rendered in a central location of the display and the third video stream may be rendered in an off-center location of the display.

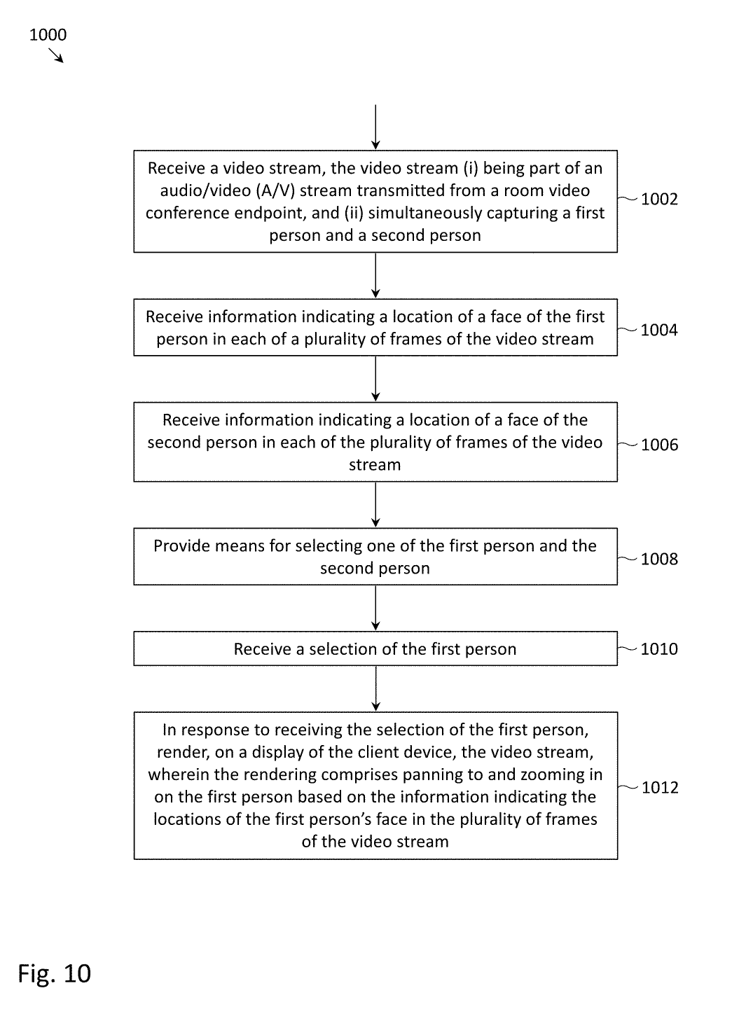

FIG. 10 depicts flow diagram 1000 of a process for receiving a video stream, receiving a selection of one of the individuals captured in the video stream and panning to and zooming in on the face of the selected individual, in accordance with one embodiment of the invention. At step 1002, client device 116 may receive a video stream. The video stream may be part of an A/V stream generated by room video conference endpoint 102, and simultaneously capture a first person and a second person. At step 1004, client device 116 may receive from video processing system (406, 506 or 606) information indicating a location of a face of the first person in each of a plurality of frames of the video stream. At step 1006, client device 116 may receive from the video processing system (406, 506 or 606) information indicating a location of a face of the second person in each of the plurality of frames of the video stream. At step 1008, client device 116 may provide means for selecting one of the first person and the second person. In one embodiment, the means for selecting one of the first person and the second person may comprise drop-down menu 150 that includes an identity of the first person and an identity of the second person. Alternatively or in addition, the means for selecting one of the first person and the second person may comprise a rendered version of the first video stream for which input directed at a region of the rendered version of the first video stream that displays the first person indicates selection of the first person and input directed at a region of the rendered version of the first video stream that displays the second person indicates selection of the second person. At step 1010, client device 116 may receive a selection of the first person from the user of client device 116. At step 1012, client device 116 may, in response to receiving the selection of the first person, render the video stream on a display of client device 116. The rendering may comprise panning to and zooming in on the first person based on the information indicating the locations of the first person's face in the plurality of frames of the video stream.

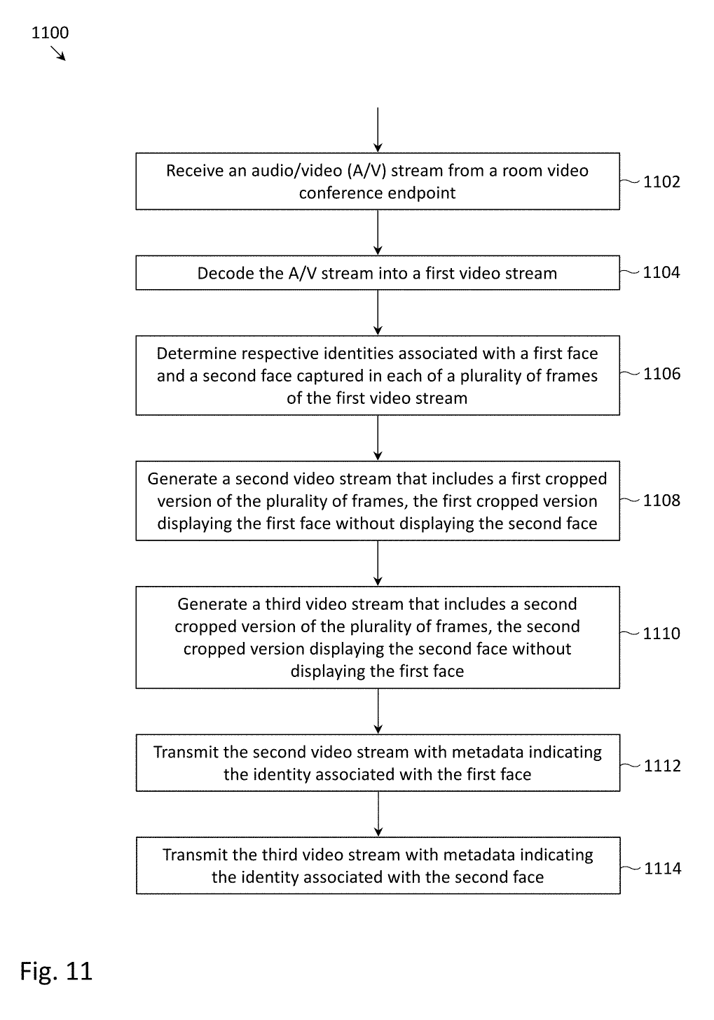

FIG. 11 depicts flow diagram 1100 of a process for decomposing a first video stream into a second and third video stream, and further associating each of the decomposed streams with an individual captured in the decomposed stream, in accordance with one embodiment of the invention. At step 1102, room media processor 104 may receive an A/V stream from room video conference endpoint 102. At step 1104, room media processor 104 may decode the A/V stream into a first video stream (and optionally a first audio stream). At step 1106, face recognizer 210 may determine respective identities associated with a first face and a second face captured in each of a plurality of frames of the first video stream. At step 1108, video decomposer 212 may generate a second video stream that includes a first cropped version of the plurality of frames, the first cropped version displaying the first face without displaying the second face. The first cropped version of the plurality of frames may be generated based on information indicating a location of the first face in each of the plurality of frames of the first video stream. At step 1110, video decomposer 212 may generate a third video stream that includes a second cropped version of the plurality of frames, the second cropped version displaying the second face without displaying the first face. The second cropped version of the plurality of frames may be generated based on information indicating a location of the second face in each of the plurality of frames of the first video stream. At step 1112, video decomposer 212 may transmit, to client device 116, the second video stream with metadata indicating the identity associated with the first face (e.g., via MFU 114). At step 1114, video decomposer 212 may further transmit, to client device 116, the third video stream with metadata indicating the identity associated with the second face (e.g., via MFU 114).

While the description so far described a face stream to focus on the face of a single individual, it is possible that a face stream could capture the respective faces of two or more individuals, for example, two or more individuals who are seated next to one another. Therefore, while face detector 110 or face recognizer 210 would still return a location stream for each of the detected faces, video decomposer 112, 212 or 312 could form a face stream based on two or more location streams.

In the embodiments of FIGS. 1A-1D and 4A-4E, in which the identity of the participants at room video conference endpoint 102 were not automatically determined by video conference systems 100 and 400, it is possible that the participants at room video conference endpoint 102 can manually input their names. For example, upon the user interface depicted in FIG. 1C being shown to the participants at room video conference endpoint 102, Rebecca may replace the tag of name placeholder (e.g., “Person 1”) with the name “Rebecca”. Alternatively or in addition, a moderator may be able to replace the name placeholders (e.g., “Person 1”) with the actual names of the participants (e.g., “Rebecca”). In one embodiment, only the moderator may be permitted to replace the name placeholders with the actual names of the participants.

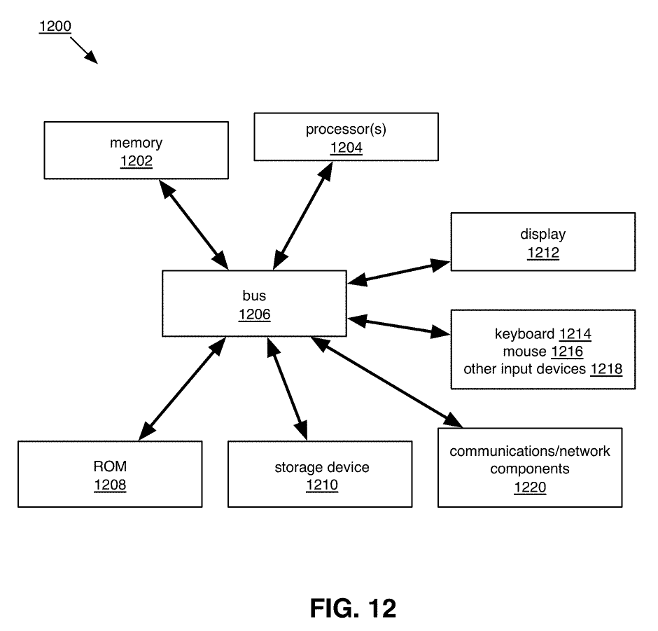

FIG. 12 depicts a block diagram showing an exemplary computing system 1200 that is representative of any of the computer systems or electronic devices discussed herein. Note that not all of the various computer systems have all of the features of system 1200. For example, systems may not include a display inasmuch as the display function may be provided by a client computer communicatively coupled to the computer system or a display function may be unnecessary.

System 1200 includes a bus 1206 or other communication mechanism for communicating information, and a processor 1204 coupled with the bus 1206 for processing information. Computer system 1200 also includes a main memory 1202, such as a random access memory or other dynamic storage device, coupled to the bus 1206 for storing information and instructions to be executed by processor 1204. Main memory 1202 also may be used for storing temporary variables or other intermediate information during execution of instructions to be executed by processor 1204.

System 1200 includes a read only memory 1208 or other static storage device coupled to the bus 1206 for storing static information and instructions for the processor 1204. A storage device 1210, which may be one or more of a hard disk, flash memory-based storage medium, magnetic tape or other magnetic storage medium, a compact disc (CD)-ROM, a digital versatile disk (DVD)-ROM, or other optical storage medium, or any other storage medium from which processor 1204 can read, is provided and coupled to the bus 1206 for storing information and instructions (e.g., operating systems, applications programs and the like).

Computer system 1200 may be coupled via the bus 1206 to a display 1212 for displaying information to a computer user. An input device such as keyboard 1214, mouse 1216, or other input devices 1218 may be coupled to the bus 1206 for communicating information and command selections to the processor 1204. Communications/network components 1220 may include a network adapter (e.g., Ethernet card), cellular radio, Bluetooth radio, NFC radio, GPS receiver, and antennas used by each for communicating data over various networks, such as a telecommunications network or LAN.

The processes referred to herein may be implemented by processor 1204 executing appropriate sequences of computer-readable instructions contained in main memory 1202. Such instructions may be read into main memory 1202 from another computer-readable medium, such as storage device 1210, and execution of the sequences of instructions contained in the main memory 1202 causes the processor 1204 to perform the associated actions. In alternative embodiments, hard-wired circuitry or firmware-controlled processing units (e.g., field programmable gate arrays) may be used in place of or in combination with processor 1204 and its associated computer software instructions to implement embodiments of the invention. The computer-readable instructions may be rendered in any computer language including, without limitation, Python, Objective C, C#, C/C++, Java, JavaScript, assembly language, markup languages (e.g., HTML, XML), and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 1200 or similar electronic computing device, that manipulates and transforms data represented as physical (electronic) quantities within its registers and memories into other data similarly represented as physical quantities within its memories or registers or other such information storage, transmission or display devices.

### EMBODIMENTS

### Embodiment 1

A method, comprising:

receiving an audio/video (A/V) stream from a room video conference endpoint;

decoding the A/V stream into a first video stream and an audio stream;

determining an identity associated with a first face in the first video stream;

determining an identity associated with a second face in the first video stream;

determining an identity of an active speaker in the audio stream;

determining that the identity of the active speaker matches the identity associated with the first face;

generating a second video stream that includes a first cropped version of the first video stream which displays the first face without displaying the second face;

generating a third video stream that includes a second cropped version of the first video stream which displays the second face without displaying the first face; and

associating the second video stream with metadata that labels the second video stream as having the active speaker.

The method of Embodiment 1, wherein the first cropped version of the first video stream is generated based on information indicating locations of the first face in the first video stream.

The method of Embodiment 1, wherein the second cropped version of the first video stream is generated based on information indicating locations of the second face in the first video stream.

### Embodiment 2

A computing system, comprising:

one or more processors;

one or more storage devices communicatively coupled to the one or more processors; and

a set of instructions on the one or more storage devices that, when executed by the one or more processors, cause the one or more processors to:
receive an audio/video (A/V) stream from a room video conference endpoint;
decode the A/V stream into a first video stream and an audio stream;
determine an identity associated with a first face in the first video stream;
determine an identity associated with a second face in the first video stream;
determine an identity of an active speaker in the audio stream;
determine that the identity of the active speaker matches the identity associated with the first face;
generate a second video stream that includes a first cropped version of the first video stream which displays the first face without displaying the second face;
generate a third video stream that includes a second cropped version of the first video stream which displays the second face without displaying the first face; and
associate the second video stream with metadata that labels the second video stream as having the active speaker.

### Embodiment 3

A non-transitory machine-readable storage medium comprising instructions that, when executed by one or more processors, cause the one or more processors to:

receive an audio/video (A/V) stream from a room video conference endpoint;

decode the A/V stream into a first video stream and an audio stream;

determine an identity associated with a first face in the first video stream;

determine an identity associated with a second face in the first video stream;

determine an identity of an active speaker in the audio stream;

determine that the identity of the active speaker matches the identity associated with the first face;

generate a second video stream that includes a first cropped version of the first video stream which displays the first face without displaying the second face;

generate a third video stream that includes a second cropped version of the first video stream which displays the second face without displaying the first face; and

associate the second video stream with metadata that labels the second video stream as having the active speaker.

### Embodiment 4

A method, comprising:

providing, at a client device, means for selecting one of a first person and a second person who are simultaneously captured in a first video stream, the first video stream being part of an audio/video (A/V) stream transmitted from a room video conference endpoint;

receiving, at the client device, a selection of the first person from a user;

receiving, at the client device and from a video decomposition system, a second video stream, the second video stream formed from cropped frames of the first video stream, and capturing a face of the first person without capturing a face of the second person;

receiving, at the client device and from the video decomposition system, a third video stream, the third video stream formed from cropped frames of the first video stream, and capturing a face of the second person without capturing a face of the first person; and rendering, on a display of the client device, the second video stream and the third video stream, wherein in response to receiving the selection of the first person, the second video stream is rendered in a more prominent fashion than the third video stream.

The method of Embodiment 4, wherein the means for selecting one of the first person and the second person comprises a drop-down menu that includes an identity of the first person and an identity of the second person.

The method of Embodiment 4, wherein the means for selecting one of the first person and the second person comprises a rendered version of the first video stream for which input directed at a region of the rendered version of the first video stream that displays the first person indicates selection of the first person and input directed at a region of the rendered version of the first video stream that displays the second person indicates selection of the second person.

The method of Embodiment 4, wherein the rendered second video stream occupies a larger area of the display than the rendered third video stream.

The method of Embodiment 4, wherein the second video stream is rendered in a central location of the display and the third video stream is rendered in an off-center location of the display.

### Embodiment 5

A client device, comprising:

means for selecting one of a first person and a second person who are simultaneously captured in a first video stream, the first video stream being part of an audio/video (A/V) stream transmitted from a room video conference endpoint;

one or more processors;

one or more storage devices communicatively coupled to the one or more processors; and

a set of instructions on the one or more storage devices that, when executed by the one or more processors, cause the one or more processors to:
receive a selection of the first person from a user;
receive from a video decomposition system, a second video stream, the second video stream formed from cropped frames of the first video stream, and capturing a face of the first person without capturing a face of the second person;
receive from the video decomposition system, a third video stream, the third video stream formed from cropped frames of the first video stream, and capturing a face of the second person without capturing a face of the first person; and
render, on a display of the client device, the second video stream and the third video stream, wherein in response to receiving the selection of the first person, the second video stream is rendered in a more prominent fashion than the third video stream.

### Embodiment 6

A non-transitory machine-readable storage medium comprising instructions that, when executed by one or more processors, cause the one or more processors to:

render, on a display of the client device, a user interface configured to receive, from a user, a selection of one of a first person and a second person who are simultaneously captured in a first video stream, the first video stream being part of an audio/video (A/V) stream transmitted from a room video conference endpoint;

receive a selection of the first person from the user;

receive from a video decomposition system, a second video stream, the second video stream formed from cropped frames of the first video stream, and capturing a face of the first person without capturing a face of the second person;

receive from the video decomposition system, a third video stream, the third video stream formed from cropped frames of the first video stream, and capturing a face of the second person without capturing a face of the first person; and

render, on the display, the second video stream and the third video stream, wherein in response to receiving the selection of the first person, the second video stream is rendered in a more prominent fashion than the third video stream.

### Embodiment 7

A method, comprising:

receiving, at a client device, a video stream, the video stream (i) being part of an audio/video (A/V) stream transmitted from a room video conference endpoint, and (ii) simultaneously capturing a first person and a second person;

receiving, at the client device and from a video processing system, information indicating a location of a face of the first person in each of a plurality of frames of the video stream;

receiving, at the client device and from the video processing system, information indicating a location of a face of the second person in each of the plurality of frames of the video stream;

providing, at the client device, means for selecting one of the first person and the second person;

receiving a selection of the first person from a user of the client device; and

in response to receiving the selection of the first person, rendering, on a display of the client device, the video stream, wherein the rendering comprises panning to and zooming in on the first person based on the information indicating the locations of the first person's face in the plurality of frames of the video stream.

The method of Embodiment 7, wherein the means for selecting one of the first person and the second person comprises a drop-down menu that includes an identity of the first person and an identity of the second person.

The method of Embodiment 7, wherein the means for selecting one of the first person and the second person comprises the rendered version of the video stream for which input directed at a region of the rendered version of the video stream that displays the first person indicates selection of the first person and input directed at a region of the rendered version of the video stream that displays the second person indicates selection of the second person.

### Embodiment 8

A client device, comprising:

one or more processors;

one or more storage devices communicatively coupled to the one or more processors; and

a set of instructions on the one or more storage devices that, when executed by the one or more processors, cause the one or more processors to:
receive a video stream, the video stream (i) being part of an audio/video (A/V) stream transmitted from a room video conference endpoint, and (ii) simultaneously capturing a first person and a second person;
receive from a video processing system, information indicating a location of a face of the first person in each of a plurality of frames of the video stream;
receive from the video processing system, information indicating a location of a face of the second person in each of the plurality of frames of the video stream;
receive a selection of the first person from a user; and
in response to receiving the selection of the first person, render, on a display of the client device, the video stream, wherein the rendering comprises panning to and zooming in on the first person based on the information indicating the locations of the first person's face in the plurality of frames of the video stream.

### Embodiment 9

A non-transitory machine-readable storage medium comprising instructions that, when executed by one or more processors, cause the one or more processors to:

receive a video stream, the video stream (i) being part of an audio/video (A/V) stream transmitted from a room video conference endpoint, and (ii) simultaneously capturing a first person and a second person;

receive from a video processing system, information indicating a location of a face of the first person in each of a plurality of frames of the video stream;

receive from the video processing system, information indicating a location of a face of the second person in each of the plurality of frames of the video stream;

receive a selection of the first person from a user; and

in response to receiving the selection of the first person, render, on a display of the client device, the video stream, wherein the rendering comprises panning to and zooming in on the first person based on the information indicating the locations of the first person's face in the plurality of frames of the video stream.

### Embodiment 10

A method, comprising:

receiving an audio/video (A/V) stream from a room video conference endpoint;

decoding the A/V stream into a first video stream;

determining respective identities associated with a first face and a second face captured in each of a plurality of frames of the first video stream;

generating a second video stream that includes a first cropped version of the plurality of frames, the first cropped version displaying the first face without displaying the second face;

generating a third video stream that includes a second cropped version of the plurality of frames, the second cropped version displaying the second face without displaying the first face;

transmitting, to a client device, the second video stream with metadata indicating the identity associated with the first face; and

transmitting, to the client device, the third video stream with metadata indicating the identity associated with the second face.

The method of Embodiment 10, wherein the first cropped version of the plurality of frames is generated based on information indicating a location of the first face in each of the plurality of frames of the first video stream.

The method of Embodiment 10, wherein the second cropped version of the plurality of frames is generated based on information indicating a location of the second face in each of the plurality of frames of the first video stream.

### Embodiment 11

A computing system, comprising:

one or more processors;

one or more storage devices communicatively coupled to the one or more processors; and

a set of instructions on the one or more storage devices that, when executed by the one or more processors, cause the one or more processors to:
receive an audio/video (A/V) stream from a room video conference endpoint;
decode the A/V stream into a first video stream;
determine respective identities associated with a first face and a second face captured in each of a plurality of frames of the first video stream;
generate a second video stream that includes a first cropped version of the plurality of frames, the first cropped version displaying the first face without displaying the second face;
generate a third video stream that includes a second cropped version of the plurality of frames, the second cropped version displaying the second face without displaying the first face;
transmit, to a client device, the second video stream with metadata indicating the identity associated with the first face; and
transmit, to the client device, the third video stream with metadata indicating the identity associated with the second face.

### Embodiment 12

A non-transitory machine-readable storage medium comprising instructions that, when executed by one or more processors, cause the one or more processors to:

receive an audio/video (A/V) stream from a room video conference endpoint;

decode the A/V stream into a first video stream;

determine respective identities associated with a first face and a second face captured in each of a plurality of frames of the first video stream;

generate a second video stream that includes a first cropped version of the plurality of frames, the first cropped version displaying the first face without displaying the second face;

generate a third video stream that includes a second cropped version of the plurality of frames, the second cropped version displaying the second face without displaying the first face;

transmit, to a client device, the second video stream with metadata indicating the identity associated with the first face; and

transmit, to the client device, the third video stream with metadata indicating the identity associated with the second face.

It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1-6. (canceled)

7. A method, comprising:
receiving an audio/video (A/V) stream from a room video conference endpoint;
decoding the A/V stream into a first video stream and an audio stream;
determining an identity associated with a first face in the first video stream;
determining an identity associated with a second face in the first video stream;
determining an identity of an active speaker in the audio stream;
determining that the identity of the active speaker matches the identity associated with the first face;
generating a second video stream that includes a first cropped version of a plurality of frames of the first video stream which displays the first face without displaying the second face;
generating a third video stream that includes a second cropped version of the plurality of frames of the first video stream which displays the second face without displaying the first face;
associating the second video stream with metadata that labels the second video stream as having the active speaker; and
facilitating a simultaneous display of the first video stream, second video stream and third video stream on a single display of a client device.

8. The method of claim 7, wherein the first cropped version of the first video stream is generated based on information indicating locations of the first face in the first video stream.

9. The method of claim 7, wherein the second cropped version of the first video stream is generated based on information indicating locations of the second face in the first video stream.

10. The method of claim 7, further comprising:
transmitting, to the client device, the second video stream with metadata indicating the identity associated with the first face; and
transmitting, to the client device, the third video stream with metadata indicating the identity associated with the second face.

11. The method of claim 7, wherein determining an identity associated with a first face in the first video stream comprises detecting the first face in the first video stream.

12. A method, comprising:
providing, at a client device, means for selecting one of a first person and a second person who are simultaneously captured in a first video stream, the first video stream being part of an audio/video (A/V) stream transmitted from a room video conference endpoint;
receiving, at the client device, a selection of the first person from a user;
receiving, at the client device and from a video decomposition system, a second video stream, the second video stream including a first cropped version of a plurality of frames of the first video stream, and capturing a face of the first person without capturing a face of the second person;
receiving, at the client device and from the video decomposition system, a third video stream, the third video stream including a second cropped version of the plurality of frames of the first video stream, and capturing the face of the second person without capturing the face of the first person; and
simultaneously rendering, on a single display of the client device, the first video stream, the second video stream and the third video stream, wherein in response to receiving the selection of the first person, the second video stream is rendered in a more prominent fashion than the first video stream and the third video stream.

13. The method of claim 12, wherein the means for selecting one of the first person and the second person comprises a drop-down menu that includes an identity of the first person and an identity of the second person.

14. The method of claim 12, wherein the means for selecting one of the first person and the second person comprises a rendered version of the first video stream for which input directed at a region of the rendered version of the first video stream that displays the first person indicates selection of the first person and input directed at a region of the rendered version of the first video stream that displays the second person indicates selection of the second person.

15. The method of claim 12, wherein the rendered second video stream occupies a larger area of the display than the rendered third video stream.

16. The method of claim 12, wherein the second video stream is rendered in a central location of the display and the third video stream is rendered in an off-center location of the display.

17-19. (canceled)
